(19) United States
(12) Patent Application Publication
(10) Pub. No.: US 2019/0228436 A1
(43) Pub. Date: Jul. 25, 2019

(54) RADIO-FREQUENCY IDENTIFICATION (RFID) BASED MARKETING APPARATUS AND METHODS

(71) Applicant: RAYMOND ANTHONY JOAO, YONKERS, NY (US)

(72) Inventor: RAYMOND ANTHONY JOAO, YONKERS, NY (US)

(21) Appl. No.: 16/217,240

(22) Filed: Dec. 12, 2018

Related U.S. Application Data
(60) Provisional application No. 62/621,412, filed on Jan. 24, 2018.

(51) Int. Cl. G06Q 30/02; G06K 7/10

(52) U.S. Cl. CPC G06Q 30/0267; G06Q 30/0261; G06K 7/10386

(57) ABSTRACT

An apparatus, including an RFID reader specially programmed to detect or read an RFID tag located on or in, or attached or affixed to, a good, product, or article; a processor; a display capable of displaying information regarding the good, product, or article, to which the RFID tag is assigned or associated; a transmitter which transmits an information request regarding the detected or read RFID tag; and a receiver which receives a report containing information regarding the good, product, or article, to which the RFID tag is assigned or associated. The RFID reader detects or reads the RFID tag. The RFID reader or the processor automatically generates the information request containing information regarding the RFID tag. The display displays information contained in the report or information regarding the good, product, or article, to which the RFID tag is assigned or associated.

### RELATED APPLICATIONS

This application claims the benefit of the priority of U.S. Provisional Patent Application Ser. No. 62/621,412, filed Jan. 24, 2018, and entitled “RADIO-FREQUENCY IDENTIFICATION (RFID) BASED MARKETING APPARATUS AND METHODS”, the subject matter and teachings of which are hereby incorporated by reference herein in their entirety.

### FIELD OF THE INVENTION

The present invention pertains to a radio-frequency identification (RFID) based marketing apparatus and methods and, in particular, to a radio-frequency identification-based marketing apparatus and methods which can be utilized to detect, identify, and provide information regarding, goods, products, or articles, of any type or kind, to individuals or users who come into a close proximity to the same and/or who are, or were, present at a venue, event, or location, where the same is or was located.

### BACKGROUND OF THE INVENTION

Global advertising spending represents hundreds of billions of dollars in spending annually. One estimate has put global advertising spending at $550 billion in 2016. It is submitted that adverting by manufacturers and retail sellers of goods, products, and articles sold in commerce, is essential in today's competitive and global marketplaces, thus substantiating the need for spending on advertising and other marketing activities.

Advertising and marketing activities for goods, products, and other articles of commerce have been known to include television advertising, infomercials, radio advertising, Internet advertising, print advertising, free give-aways, product placements in television programs and movies, and/or various promotions, and/or any combination of same.

It is submitted that an often overlooked, and under-rated, method for advertising and/or marketing a good, product, or article lies in individuals observing the same in and during everyday life situations. For example, a woman observing another women wearing a dress on a public street at am event, a man observing another man wearing a watch, a child observing another child playing with a technology gadget or a toy, and numerous many other situations, are all examples of how an observation of a good, product, or article, being worn or used in an everyday life situation can serve to advertise or market that respective good, product, or article. In the above-described everyday life situations, however, unless the observing individual who is observing or has observed the good, product, or article, is able to, or who is forward enough to, approach the individual who is wearing or using the good, product, or article, in order to inquire about the same, the observing individual can remain clueless as to the name, price, description, manufacturer, and/or retailer seller(s), of the good, product, or article. Since observing individuals may be reluctant to approach strangers with such questions, advertising and marketing opportunities regarding the observed good, product, or article, and potential sales opportunities for the same, can be lost.

### SUMMARY OF THE INVENTION

The present invention pertains to a radio-frequency identification (RFID) based marketing apparatus and methods and, in particular, to a radio-frequency identification-based marketing apparatus and methods which can be utilized to detect, identify, and provide information regarding, goods, products, or articles, of any type or kind, which overcomes the shortcomings of the prior art.

In implementing and in using the present invention, radio frequency identification (RFID) tags can be attached to, affixed to, or placed on or in, any good, product, or article of commerce. The RFID tag can contain information regarding the respective good, product, or article of commerce, including, for example, but not limited to, the name of the respective good, product, or article of commerce, the manufacturer of same, the brand name of same or the product line of same, the model number of same, a serial number of or for same, a description of same, available sizes for same, a price or prices for same, information identifying one or more retail sellers of same, and/or any other information regarding same such as, for example, but not limited to, information regarding use, cleaning, washing, and/or care, instructions (if applicable). At the time of sale, the RFID tag can be registered to the purchaser of the respective good, product, or article of commerce, if desired.

Once the good, product, or article of commerce, with the RFID tag, is sold and in use, any user or individual of the present invention can, with any suitable RFID reader described herein can, when in proximity to or located near the good, product, or article of commerce, or the person wearing, holding, or utilizing the same, obtain information regarding the respective good, product, or article of commerce, of interest to him or her. Thereafter, the user or individual can use the information obtained via the RFID reader in order to obtain information regarding the respective good, product, or article of commerce, for purposes of identifying the same, obtaining information regarding the same, finding a retail seller of same, and/or simply purchasing the same.

With regards to the present invention, RFID readers can be utilized at venues for various social, entertainment, sporting, or any other, events, and RFID tags can be read as attendees of the respective event enters the respective venue. Thereafter, if a user or individual should see a good, product, or article of commerce, in the crowd, or on, worn by, carried by, or being used by a person in attendance, the user or individual can query the list of RFID tags read for the event to find and to identify the respective good, product, or article of commerce, of interest to him or her. Thereafter, the user or individual can use the information obtained in order to obtain information regarding the respective good, product, or article of commerce, for purposes of identifying the same, obtaining information regarding the same, finding a retail seller of same, and/or simply purchasing the same.

The user or individual can obtain information regarding any good, product, or article of commerce, he or she may come across in everyday life situations, provided that the good, product, or article of commerce, is equipped with an RFID tag, without having to approach or to speak with the person who is wearing, holding, or using the respective good, product, or article of commerce. Manufacturers, retailers, and marketers, of any types of kinds of goods, products, and/or articles of commerce, can use the present invention to market their goods, products, and/or articles of commerce, via previous purchasers or users of same. Users or individuals who agree to have their name of other identifying information registered along with the RFID tag, which is attached to, affixed to, or placed on or in, any good, product, or article of commerce, at the time of purchase, or at any time thereafter, can receive compensation, via an affiliated marketing program, any time(s) their wearing, holding, or use, of a respective good, product, or article of commerce, having an RFID tag, results in a purchase by another user or individual of the respective good, product, or article of commerce, or any other good(s), product(s), or article(s) of commerce.

The present invention can be utilized in a wide variety of ways in order to allow manufacturers, retail sellers, and/or marketers, of any types or kinds of goods, products, or articles of commerce, to market the same via previous purchasers or users of same in everyday life situations and/or in other situations.

The present invention can include a central processing computer or server computer, which can include any number of central processing computers and/or computer systems. Any number of central processing computers can be utilized in the present invention. The central processing computer can be specially programmed and specially configured to perform all of the various operations, functions, and functionalities, described herein as being performed by the same, as well as to perform all of the operations, functions, and functionalities, described herein as being performed by the present invention. The central processing computer can be associated with, and/or can used by, any manufacturer(s), wholesaler, retailer, or marketer, of any type or kind of goods, products, or articles of commerce, and/or by any other type or kind of operator.

The present invention can also include any number of user computers or user communication devices which can be utilized by any user, individual, party, or entity, who or which uses the present invention in order to communicate with the central processing computer(s) described herein and/or to communicate with any of the other computers and communication devices described herein as being utilized in or with the present invention. The user communication device can communicate with, and/or can be linked with, the central processing computer(s) and/or any other computers or communication devices described herein, via a wired communication network, a wireless communication network, or via any combination of wired and/or wireless communication networks.

The user communication device can be utilized by any of the herein-described users in order to interface with, and/or interact with, the central processing computer or with any of the other computers and communication devices described herein as being used in or with the present invention. The user communication device can be a computer, a computer terminal, a terminal device connected to, or associated with, the central processing computer, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The user communication device can also be a server computer, a network computer, or any other computer capable of being utilized in a network.

The user communication device can also include and/or can be utilized in conjunction with a network computer or any other computer which can be utilized to send and receive text messages and/or e-mail messages for or on behalf of a user. The network computer can be any computer which can be used in a computer communication network to transmit and/or to receive text messages or e-mail messages to and/or from any of the herein-described user communication devices and/or can provide a text message or an e-mail message to the user communication device. The respective network computer or other computer can also automatically transmit or “push” a text message or an e-mail message or e-mail messages to a user communication device as soon as same are received, in real-time, and/or in any other manner.

The respective network computer or other computer can also serve as a conventional text message server or as an e-mail server which can allow a user to request or “pull” a text message or an e-mail message or e-mail messages to a user communication device when requested by the user or other authorized individual. In this regard, any network computer or other computer, such as one that can receive and send text messages or email messages to a user communication device is also considered to be a user communication device. In this regard, any text message server or any e-mail server can also be deemed to be a user communication device. Each user communication device can also have a website or websites associated therewith.

Any number of user communication devices can be utilized in, or in connection with, the present invention. The user communication devices can be utilized to communicate with the central processing computer(s) and/or with any other computers or communication devices described herein in a bi-directional manner.

The present invention also includes any number of radio frequency identification (RFID) tags, with each RFID tag being attached to, affixed to, or placed on or in, a respective good, product, or article of commerce. The RFID tags can be of any suitable type or kind, and can be selected from among the various types or kinds of RFID tags which are available in the marketplace as of the filing date of this patent application. The RFID tags can be passive RFID tags and/or active RFID tags. The RFID tags should also be waterproof, washable, and/or otherwise be capable of being cleaned, and they should be temperature resistant and durable, in order to be utilized in connection with, or in conjunction with, all types and kinds of clothing or apparel, shoes, boots, hats, gloves, accessories, and other wearable objects and/or articles, as well as in connection with, or in conjunction with, any and/or all types or kinds of goods, products, or articles of commerce. Any type or kind of RFID tag can be utilized in connection with the present invention provided that the respective RFID tag is suitable for use in its particular application. Any number of RFID tags can be utilized in connection with the present invention. Further, in a preferred embodiment, passive RFID tags can be utilized in any situation where a respective tag may not be capable of having its own power source. In situations where RFID tags can be provided with a power source, then active RFID tags can be used. Passive RFID tags can provide for the most convenient use since they do not have or require a power source, but rather, they can be energized and operate when activated by a suitable RFID reader device.

The present invention also includes any number of RFID reader systems which can be, or can include, any suitable RFID reader. Each RFID reader system can be reader for passive RFID tags or can be a reader for active RFID tags depending upon the application. Each RFID reader system can be utilized to read any of the RFID tags described herein as being utilized in connection with the present invention.

The RFID reader system can communicate with and/or to interact with the central processing computer(s), the user communication devices, and/or with any of the other computers and communication devices described herein as being used in or with the present invention The RFID reader system can communicate with, and/or be linked with, the central processing computer(s) and/or any other computer or communication devices described herein, via a wired communication network, a wireless communication network, or via any combination of wired and/or wireless communication networks.

The present invention can also include any number of venue computers, with each venue computer being assigned to a venue which can be the site of social events, entertainment events, sporting events, or any other events or gatherings, as well as which can be any type or kind of place of business, educational institution, or other public venue. Each venue computer can include, be equipped with, or have assigned thereto, an RFID reader or RFID reader system, or any number of RFID readers or RFID reader systems. Each venue computer should also be equipped with one or more RFID reader or RFID reader systems for reading any of the RFID tags that can enter the respective venue with which the venue computer is associated.

The venue computer can communicate with and/or interact with the central processing computer(s), the user communication devices, the RFID reader systems, and/or with any of the other computers and communication devices described herein as being utilized in or with the present invention. The venue computer can communicate with, and/or can be linked with, the central processing computer(s) and/or any other computer or communication devices described herein, via a wired communication network, a wireless communication network, or via any combination of wired and/or wireless communication networks.

The venue computer can also be used by a respective venue in order to interface with, and/or interact with, the central processing computer or with any other computers and communication devices described herein as being used in or with the present invention. Each venue computer can include any number of computers, server computers, or computer systems. Each venue computer can also have a website or websites associated therewith.

The present invention can also include any number of manufacturer computers, each of which can be associated with and used by any manufacturer which utilizes the present invention. Any number of manufacturer computers can be utilized in connection with the present invention. The manufacturer computer can communicate with and/or interact with the central processing computer(s), the user communication devices, the RFID reader systems, and/or with any of the other computers and communication devices described herein as being utilized in or with the present invention. The manufacturer computer can communicate with, and/or can be linked with, the central processing computer(s) and/or any other computer or communication devices described herein, via a wired communication network, a wireless communication network, or via any combination of wired and/or wireless communication networks.

The manufacturer computer can be used by a respective manufacturer in order to interface with, and/or interact with, the central processing computer or with any other computers and communication devices described herein as being used in or with the present invention. Each manufacturer computer can include any number of computers, server computers, or computer systems. Each manufacturer computer can also have a website or websites associated therewith.

The present invention can also include any number of retailer computers, each of which can be associated with and used by any retail sellers, retail stores, or on-line retail sellers, which utilizes the present invention. Any number of retailer computers can be utilized in connection with the present invention. The retailer computer can communicate with and/or interact with the central processing computer(s), the user communication devices, the RFID reader systems, and/or with any of the other computers and communication devices described herein as being utilized in or with the present invention. The retailer computer can communicate with, and/or can be linked with, the central processing computer(s) and/or any other computer or communication devices described herein, via a wired communication network, a wireless communication network, or via any combination of wired and/or wireless communication networks.

The retailer computer can be used by a respective retailer in order to interface with, and/or interact with, the central processing computer or with any other computers and communication devices described herein as being used in or with the present invention. Each retailer computer can include any number of computers, server computers, or computer systems. Each retailer computer can also have a website or websites associated therewith.

The present invention can also include any number of advertiser/marketing entity computers, each of which can be associated with and used by any advertiser or marketing entity of any type or kind which utilizes the present invention. Any number of advertiser/marketing entity computers can be utilized in connection with present invention.

The advertiser/marketing entity computer can communicate with and/or interact with the central processing computer(s), the user communication devices, the RFID reader systems, and/or with any of the other computers and communication devices described herein as being utilized in or with the present invention. The advertiser/marketing entity computer can communicate with, and/or can be linked with, the central processing computer(s) and/or any other computer or communication devices described herein, via a wired communication network, a wireless communication network, or via any combination of wired and/or wireless communication networks.

The advertiser/marketing entity computer can be used by a respective advertiser or marketing entity in order to interface with, and/or interact with, the central processing computer or with any other computers and communication devices described herein as being used in or with the present invention. Each advertiser/marketing entity computer can include any number of computers, server computers, or computer systems. Each advertiser/marketing entity computer can also have a website or websites associated therewith.

The present invention can also include a social network computer which can be used by any social networking company or any social networking provider to provide social networks, social networking services, and/or social networking forums, to and/or for, any of the users of the present invention. Each social network computer can include any number of computers, server computers, or computer systems. The social network computer can be utilized by a respective social networking company or a social networking provider associated with the same in order to communicate with and/or to interact with the central processing computer(s), the user communication devices, the RFIF system(s), the venue computer(s), the manufacturer computer(s), the retailer computer(s), the advertiser/marketing entity computer(s), and/or any of the other computers and communication devices described herein as being utilized in or with the present invention.

The social network computer can communicate with, and/or be linked with, the central processing computer(s), any of the user communication devices, and/or any other computers or communication devices described herein, via a wired communication network, a wireless communication network, or via any combination of wired and/or wireless communication networks. Each social network computer can include any number of computers, server computers, or computer systems. Each social network computer can also have a website or websites associated therewith.

The present invention can also include a financial institution computer which can be used by, and/or which can be associated with a bank or other financial institution for maintaining financial accounts for any of the users, individuals, venues, manufacturers, retailers, advertisers, marketing entities, and/or social networks who of which utilize the present invention. The financial institution computer can communicate with and/or can interact with the central processing computer(s), the user communication devices, the RFIF system(s), the venue computer(s), the manufacturer computer(s), the retailer computer(s), the advertiser/marketing entity computer(s), and/or any of the other computers and communication devices described herein as being utilized in or with the present invention. The financial institution computer can communicate with, and/or be linked with, the central processing computer(s), any of the user communication devices, and/or any other computers or communication devices described herein, via a wired communication network, a wireless communication network, or any combination of wired and/or wireless communication networks. Each financial institution computer can include any number of computers, server computers, or computer systems. In a preferred embodiment, each financial institution computer can also have a website or websites associated therewith.

Any of the central processing computer(s), the user communication devices, the RFID systems, the venue computers, the manufacturer computers, the retailer computers, the advertiser/marketing entity computers, the social network computers, and/or the financial institution computers, can communicate with, transmits data and/or information to, and/or receive data and/or information from, any, or any other, central processing computer(s), the user communication devices, the RFID systems, the venue computers, the manufacturer computers, the retailer computers, the advertiser/marketing entity computers, the social network computers, and/or the financial institution computers, described herein in a bi-directional manner and/or in any other manner. In this regard, any computer or communication device described herein can communicate, in a bi-directional manner and/or in any other manner, with any other computer or communication device regardless of whether the respective computer or communication device is a central processing computer, the user communication device, an RFID system, a venue computer, a manufacturer computer, a retailer computer, an advertiser/marketing entity computer, a social network computer, and/or a financial institution computer.

In the preferred embodiment, the present invention can be utilized on, over, or via, the Internet and/or the World Wide Web. The present invention can also be utilized over any suitable communication network and/or any combination of computer networks, including, but not limited to the Internet, the World Wide Web, a telecommunication network or system, a telephone network or system, a cable television communication network or system, a satellite television communication network or system, a digital television network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video and communication network or system, a streaming audio communication network or system, a live video communication network or system, and/or any other suitable communications network or system, and/or any combination(s) thereof.

The central processing computer can include a central processing unit (CPU), a random access memory (RAM) device(s), a read only memory (ROM) device(s), a user input device(s), a display device(s), an output device(s), a receiver(s), a transmitter(s), a database(s), a global positioning device, and a video and/or audio recording device(s).

The user communication device can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), a global positioning device, and an RFID reader.

The RFID reader system can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), a global positioning device, and an RFID reader.

The venue computer can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), a global positioning device, and an RFID reader.

The manufacturer computer can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), a global positioning device, and an RFID reader.

The retailer computer can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), a global positioning device, and an RFID reader.

The advertiser/marketing entity computer can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), a global positioning device, and an RFID reader.

The social network computer can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), and a global positioning device.

The financial institution computer can include a central processing unit or CPU, a random access memory (RAM) device(s), a read only (ROM) memory device(s), a user input device(s), a display device(s), a transmitter(s), a receiver(s), a database(s), an output device(s), a video and/or audio recording device(s), and a global positioning device.

The present invention can be utilized in a number of embodiments in order to allow users and individuals to identify and/or to be made aware of, and/or to obtain, or to be provided with, information regarding, any good, product, or article of commerce, which is equipped with an RFID tag, and/or to allow manufacturers, retailers, retail sellers, advertisers, and/or marketing entities, to promote, advertise, and/or sell or market, their respective goods, products, or articles of commerce, via the present invention.

It is envisioned that all users, individuals, venues, manufacturers, retailers, retail sellers, advertisers, social networking entities, and/or financial institutions, can create, establish, and/or register, an account with the central processing computer and/or apparatus of the present invention so as to become users or members of same.

The present invention can be utilized in connection with any goods, products, or articles of commerce, including, but not limited to apparel and/or clothing, fashion apparel and/or clothing, designer apparel and/or clothing, accessories of any and/or types or kinds, footwear, handbags, hats and/or other headwear, jackets and/or coats, bathing suits, jewelry of any and/or all types or kinds, watches of any and/or all types of kinds, computers, tablets, cellular telephones, smart phones, personal digital assistants, e-readers, and other consumer electronics products, of any and/or all types or kinds, consumer products of any and/or all types or kinds, exercise equipment, bicycles, and/or vehicles, of any and/or all types or kinds, consumer and/or personal products of any and/or types or kinds, and/or any other good(s), product(s), and/or article(s) of commerce, of any and/or all types or kinds. The present invention can be utilized with any type or kind of good(s), product(s), or article(s) of commerce, to which or in which any suitable or appropriate RFID tag can be attached, affixed, or placed.

The present invention can also be utilized in connection with, and/or in conjunction with, any number of types or kinds of suitable and/or appropriate RFID tags which are available in the marketplace as of the filing date of the present application, as well those suitable and/or appropriate RFID tags which can be provided in the future. The RFID tags can be passive RFID tags or active RFID tags depending upon the application.

The present invention can also be utilized in connection with, and/or in conjunction with, any number of types or kinds of suitable and/or appropriate RFID readers which are available in the marketplace as of the filing date of the present application, as well those suitable and/or appropriate RFID readers which can be provided in the future. The RFID readers can be RFID readers for passive RFID tags or for active RFID tags depending upon the application.

Any data and/or information regarding any good, product, or article of commerce, with which the present invention can be used, can be stored in the database of the central processing computer. Data and/or information regarding each respective good, product, or article of commerce, can, for example, include, but not be limited to, the name or a generic description, a brand name, the manufacturer or manufacturers, one or more retailers or retail sellers, the price, available sizes, available colors, reviews, warranty information, use instructions, care instructions, cleaning instructions, washing instructions, available sales or discounts, available discount coupons, a link or links to a retailer(s) or retail seller(s) from which the good, product, or article of commerce, can be purchased, a link or links to a manufacturer website, a retailer or retail seller website, and/or a social network webpage, and/or any other information, of, for, or regarding, the respective good, product, or article of commerce (hereinafter also referred to as the “good, product, or article, information”).

Any data and/or information regarding any RFID tag with which the present invention can be used, can also be stored in the database of the central processing computer. Data and/or information regarding each RFID tag can, for example, include, but not be limited to, the name, manufacturer, type of RFID tag (such as, for example, passive RFID tag or active RFID tag), and/or any other information regarding, each respective RFID tag.

Any data and/or information regarding any RFID reader with which the present invention can be used, can also be stored in the database of the central processing computer. Data and/or information regarding each RFID reader can, for example, include, but not be limited to, the name, manufacturer, type of RFID reader (such as, for example, passive RFID reader or active RFID reader), and/or any other information regarding, each respective RFID reader.

Each RDIF tag utilized with the present invention can be assigned a unique serial number of other unique identification number or identifier number or code. Each RFID tag can be assigned to each good, product, or article of commerce, sold by a manufacturer, a retailer, a retail seller, or a distributor, upon the sale of the same, or by a respective manufacturer, retailer, retail seller, on-line seller, distributor, or shipper, upon a shipment of the same. In this regard, a unique RFID tag can be assigned to each respective good, product, or article of commerce, to which it is attached or affixed, or on or in which it is placed, by an appropriate entity at the appropriate time before delivery or shipment of the respective good, product, or article of commerce, to a purchasing consumer, user, or individual. Any data and/or information regarding each RFID tag utilized with the present invention, along with data and/or information regarding the respective good, product, or article of commerce, to which the RFID tag is assigned, can also be stored and maintained in the database of the central processing computer.

An RFID tag can be attached to, affixed to, or placed on or in, a good, product, or article of commerce, by its respective manufacturer, distributor, or retailer or retail seller, or shipper, at any appropriate time, and the RFID tag can then be registered with, and/or associated with, the respective good, product, or article of commerce. Upon being registered or becoming associated with the RFID tag, information regarding the good, product, or article of commerce, can be accessible via the information read from the RFID tag.

Each user or individual who uses the present invention can create a user account with the present invention. The user account can store any of the herein-described data and/or information regarding the user or individual. The user account for each user or individual can also store information regarding each RFID tag which is registered with the user or individual, as described herein, along with data and/or information regarding the respective good, product, or article of commerce, to which each RFID tag is assigned. Each RFID tag can be attached to, affixed to, or place on or in, the respective good, product, or article of commerce, to which the RFID tag is assigned.

The present invention can be utilized in any number of various preferred embodiments in order to allow the herein-described users, individuals, venues, manufacturers, retailers, retail sellers, advertisers, social networking entities, and/or financial institutions, to benefit from the same in a variety of ways.

A user or individual can create, establish, and/or register, a user account with the present invention. The user account can contain data and/or information regarding any number of RFID tags which are registered to the user as well as any data and/or information regarding each good, product, or article of commerce, to which each RFID tag is assigned. The user or individual, at any time, can access and update data and/or information in his or her user account and/or can add new information to the same. Once an RFID tag is assigned to a good, product, or article of commerce, such as by being attached to, affixed to, or placed on or in, the respective good, product, or article of commerce, by a respective manufacturer, distributor, or retailer or retail seller, or shipper, the RFID tag can then be registered with the present invention. Once the respective RFID tag is registered with the present invention, information regarding the respective good, product, or article of commerce, to which the RFID tag is assigned, can then be obtained by, or provided to, any user or individual upon the reading of the RFID tag with an appropriate RFID reader or an appropriate RFID reader system.

The user or individual can utilize the personal RFID reader or the personal RFID reader system, along with his or her user communication device, to read an RFID tag which is attached to, affixed to, or placed on or within, any good(s), product(s), or article(s) of commerce, of interest to the user or individual. Thereafter, the user or individual can retrieve, obtain, or otherwise be provided with any information regarding the respective good, product, or article of commerce, and/or the good, product, or article, information, of or for the respective good, product, or article of commerce, to which the respective RFID tag is assigned. Thereafter, the user or individual can shop for the good, product, article of commerce, and/or engage in any other activities.

The user or individual can utilize the personal RFID reader or the personal RFID reader system, along with his or her user communication device, to read any number of RFID tags each of which can be attached to, affixed to, or placed on or within, any good(s), product(s), or article(s) of commerce, which is detected within a predetermined distance or radius of the user's or individual's user communication device. At any time, or at pre-defined time intervals, the user or individual, or his or her user communication device, can transmit a request to retrieve, obtain, or otherwise be provided with, a report, which can be searchable and which can contain or include, for each detected RFID tag and its respective good, product, or article of commerce, any of the herein-described information regarding the good, product, or article of commerce, and/or the herein-described good, product, or article, information, of or for each respective good, product, or article of commerce.

The user or individual who may have seen a good, product, or article of commerce, which may have caught his or her attention, in or at any location, can request, be provided with, and review, the report to see if the respective good, product, or article of commerce, was equipped with, or assigned, an RFID tag in order to allow the user or individual to obtain information regarding the same, and/or, to engage in a subsequent shopping activity for the respective good, product, or article of commerce.

The present invention can also be utilized to detect and read any and/or all RFID tags, each associated with a respective good(s), product(s), or article(s) of commerce, which enter into any event or venue. In such an instance or situation, RFID readers of the venue computer associated with the respective venue where the event to activity is taking place, other RFID readers, or any RFID reader systems, can be located at venue entrances to the event or activity so as to detect and to read each RFID tag which enters into the venue, event or activity. At any time before, during, or after, the event the event of activity, information regarding each detected and read RFID tag can be transmitted to the central processing computer, and a venue, event, or activity, report can be generated containing of including, for each detected and read RFID tag, information regarding the good, product, or article of commerce, and/or the good, product, or article, information, for each respective good, product, or article of commerce, to which a respective detected and read RFID tag is assigned or registered.

The venue, event, or activity, report can also contain or include information, for each respective good, product, or article of commerce, a link(s), or hyperlink(s) to any information regarding each respective good, product, or article of commerce, and/or a link(s) or hyperlink(s) to any manufacturer, retailers, or retail sellers, of each respective good, product, or article of commerce. The user or individual can, at any time, request to retrieve, obtain, or otherwise be provided with, the venue, event, or activity, report, which can be searchable so as to allow the user of individual to search for one or more good(s), product(s), or article(s) of commerce.

The user or individual can, using his or her user communication device, review the venue, event, or activity, report, search the venue, event, or activity, report using any search words, terms, or phrases, and/or use any search filters, in order to retrieve, obtain, or otherwise be provided with the information regarding each good, product, or article of commerce, associated with each detected and read RFID tag, which is of interest to the user or individual. As and for an example, a user or individual, who may have seen a good, product, or article of commerce, which may have caught his or her attention, such as a woman user attending a formal event who has seen a dress, gown, other item of clothing, or accessory, worn by or possessed by another woman in attendance at the venue, event, or activity, can request, and can be provided with, and can review, the venue, event, or activity, report to see if the respective dress, gown, other item of clothing, or accessory was equipped with an RFID tag and, if so, allow the woman to obtain information regarding the respective dress, gown, other item of clothing, or accessory.

At any time before, during, or after, the herein-described operation of the present invention, the central processing computer, any/or any one or more of the venue computers, the manufacturing computers, the retailer computers, the advertising/marketing entity computers, the social network computers, and/of the financial institution computers, can, transmit information, marketing materials or information, advertising materials or information, social networking information, and/or any other materials or information to the user communication and/or to any other user communication device used by, or associated with the user or individual.

The present invention can also be utilized in order to calculate and effectuate a payment, a referral fee, or a commission payment, to a user or individual if the detection and reading of an RFID tag registered to that user or individual results in a purchase of the respective good, product, or article of commerce, or any other good, product, or article of commerce, of any manufacturer, retailer, or retail seller, which is a member of, or which utilizes, the present invention.

### BRIEF DESCRIPTION OF THE DRAWINGS

### In the Drawings:

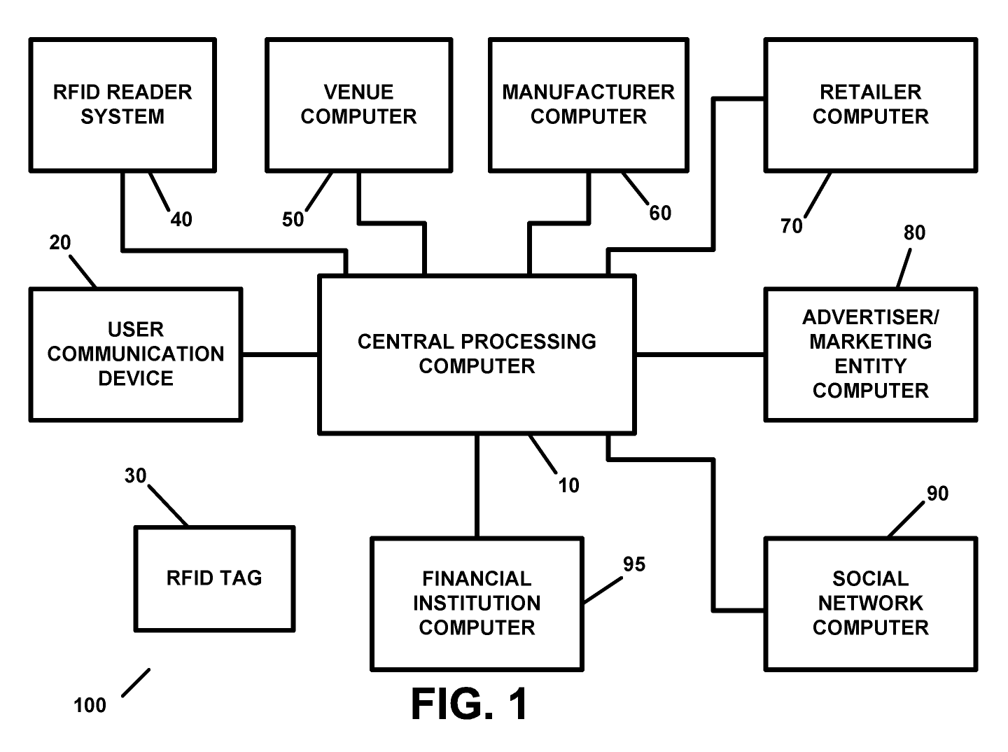

FIG. 1 illustrates a preferred embodiment of the apparatus of the present invention, in block diagram form;

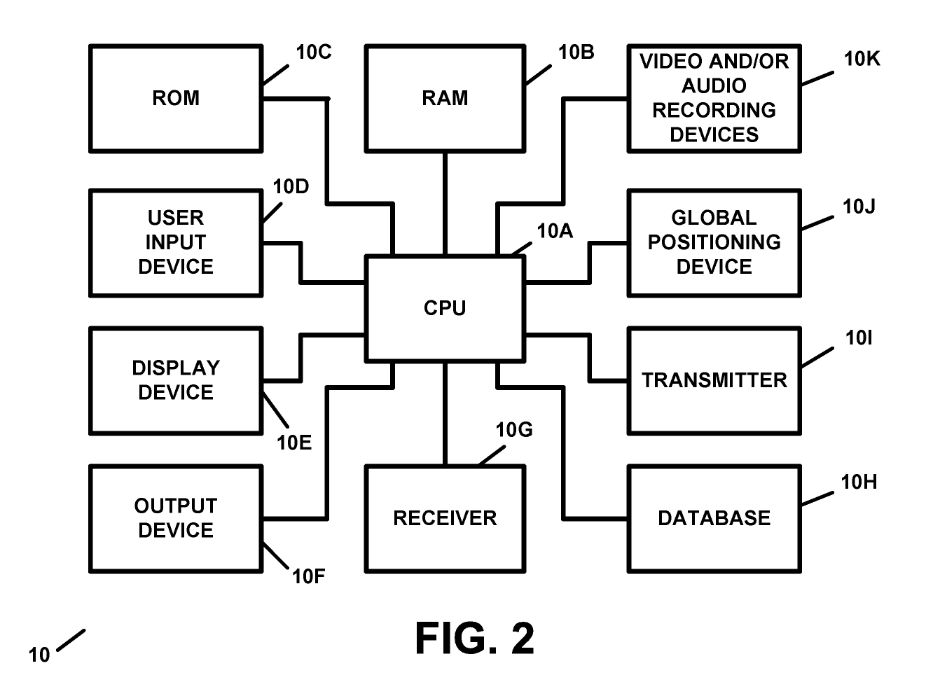

FIG. 2 illustrates the central processing computer of FIG. 1, in block diagram form;

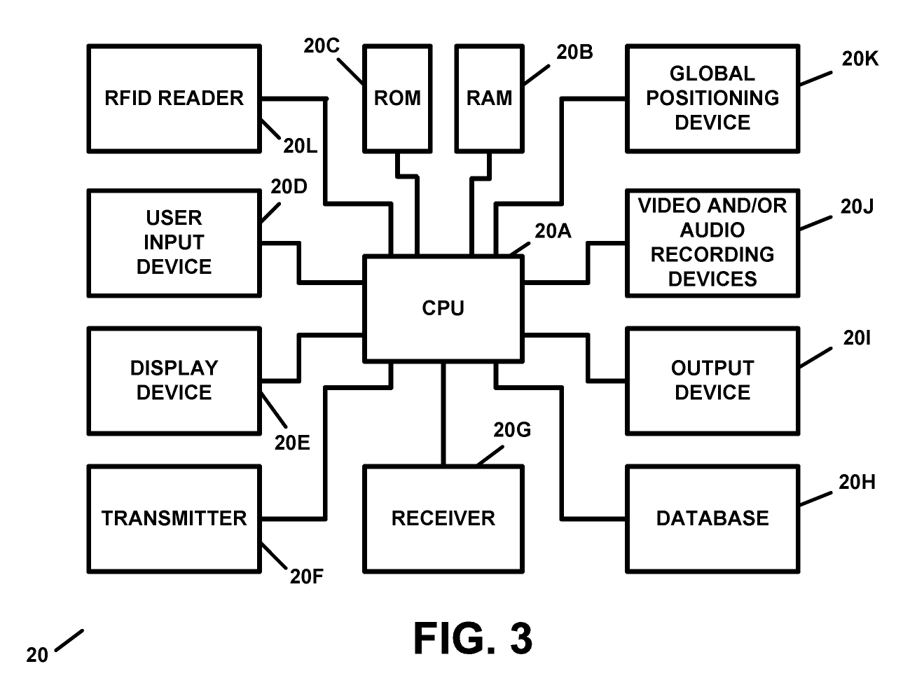

FIG. 3 illustrates the user communication device of FIG. 1, in block diagram form;

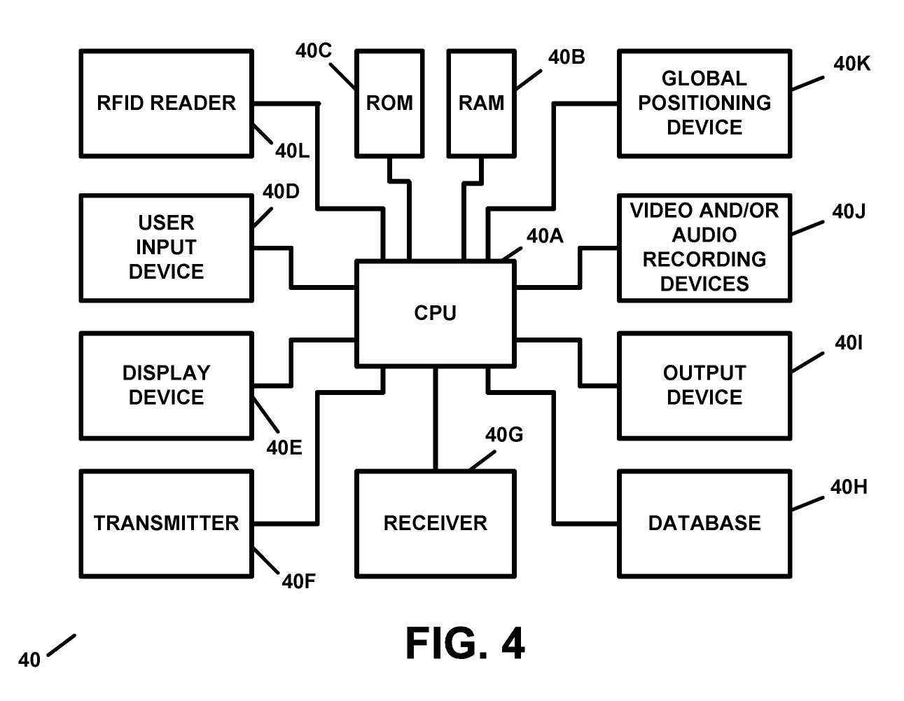

FIG. 4 illustrates the RFID reader system of FIG. 1, in block diagram form;

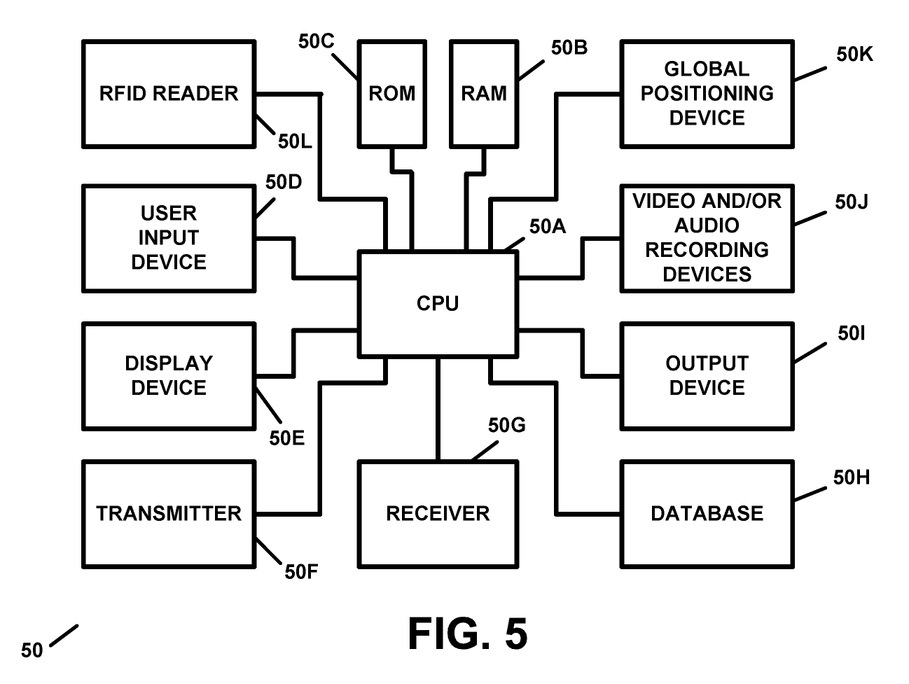

FIG. 5 illustrates the venue computer of FIG. 1, in block diagram form;

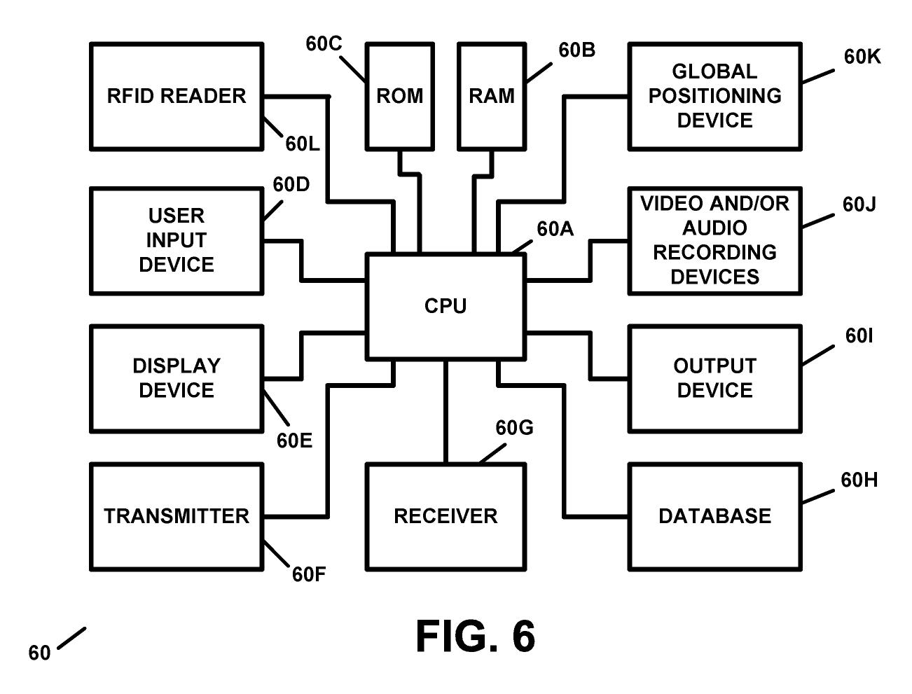

FIG. 6 illustrates the manufacturer computer of FIG. 1, in block diagram form;

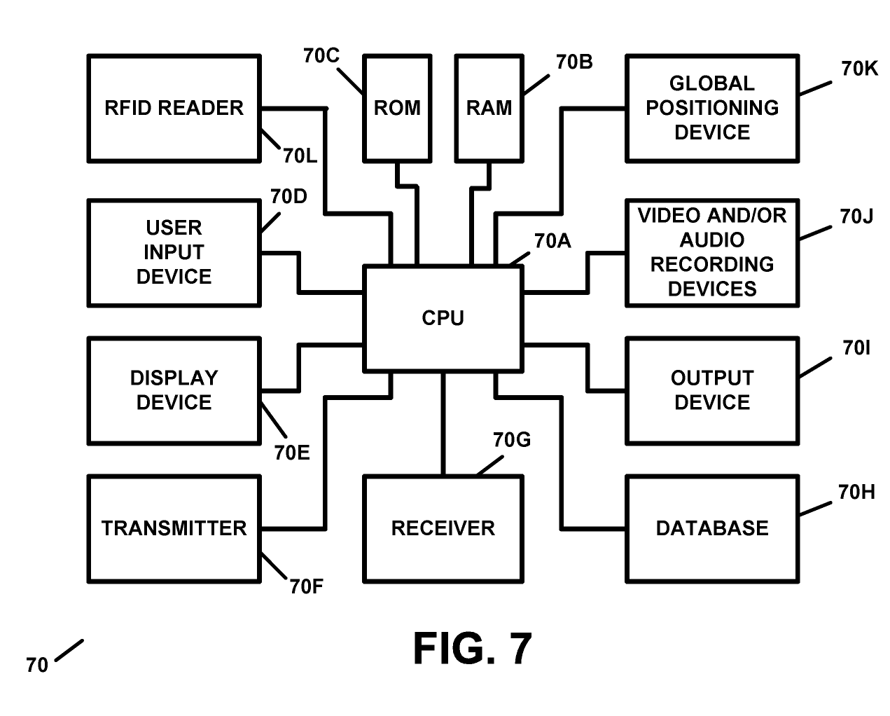

FIG. 7 illustrates the retailer computer of FIG. 1, in block diagram form;

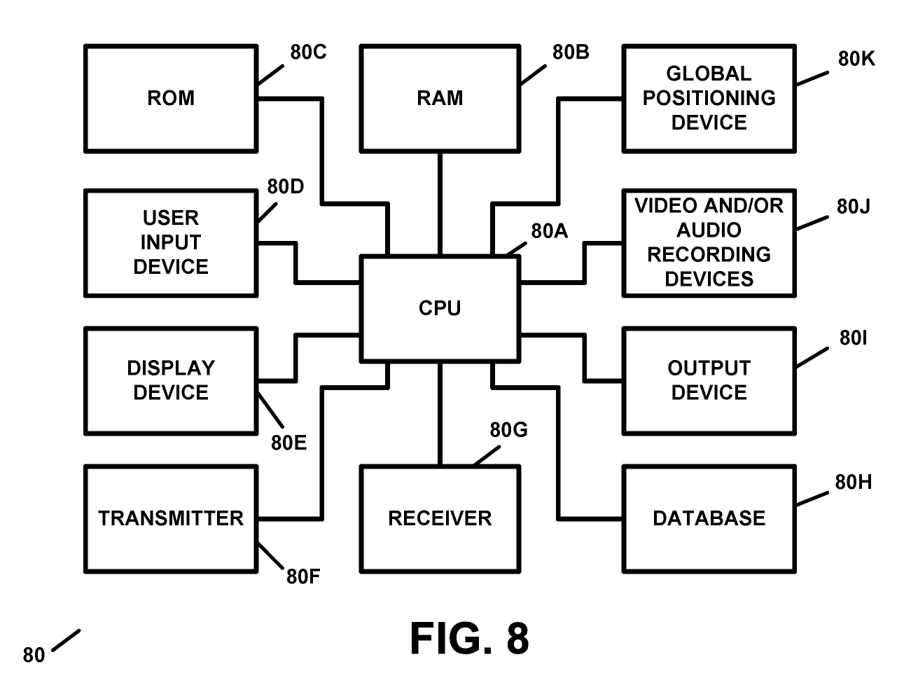

FIG. 8 illustrates the advertiser/marketing entity computer of FIG. 1, in block diagram form;

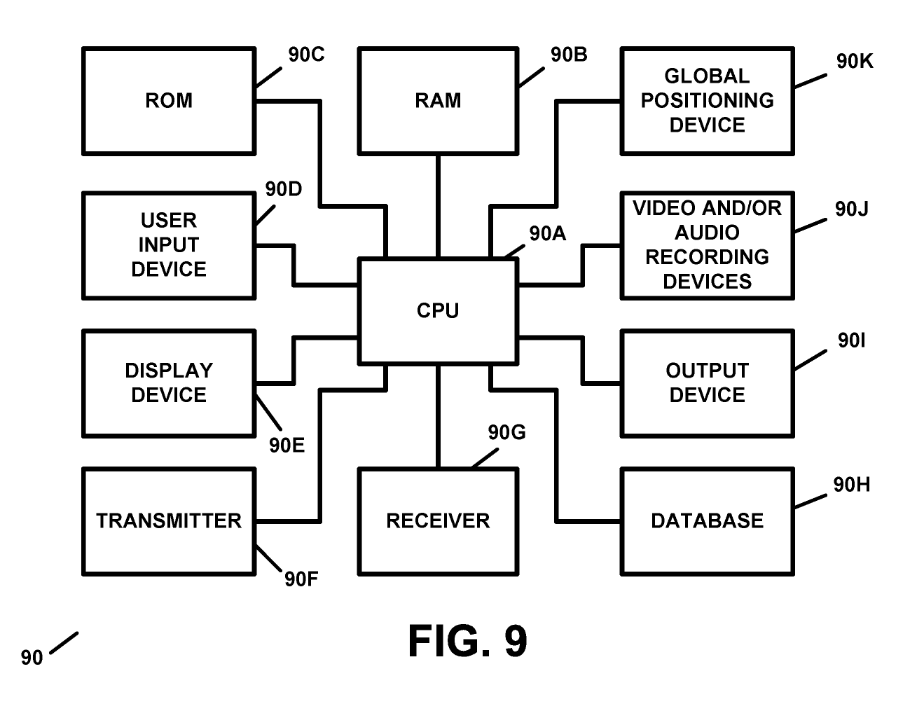

FIG. 9 illustrates the social network computer of FIG. 1, in block diagram form;

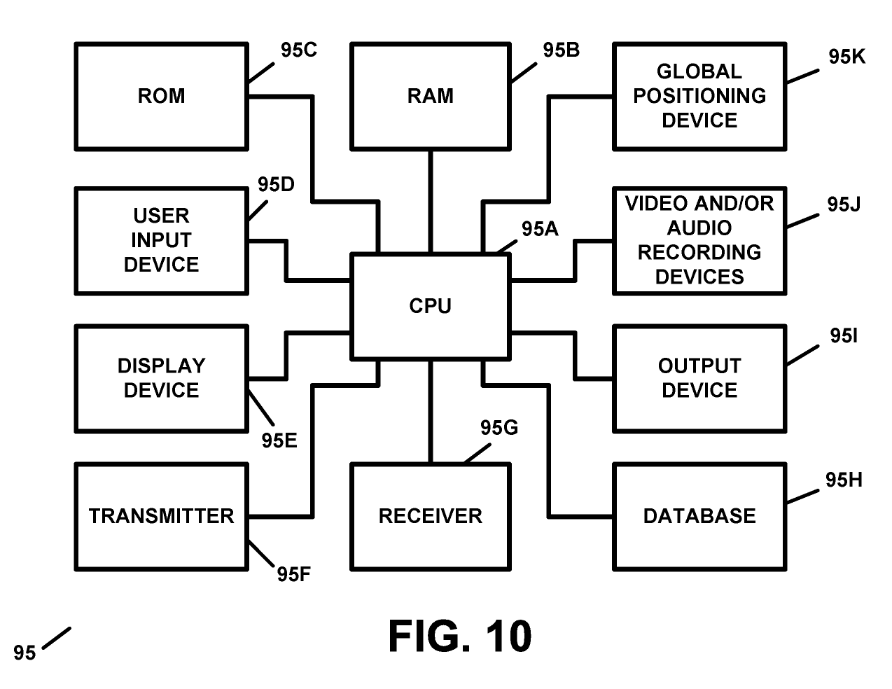

FIG. 10 illustrates the financial institution computer of FIG. 1, in block diagram form;

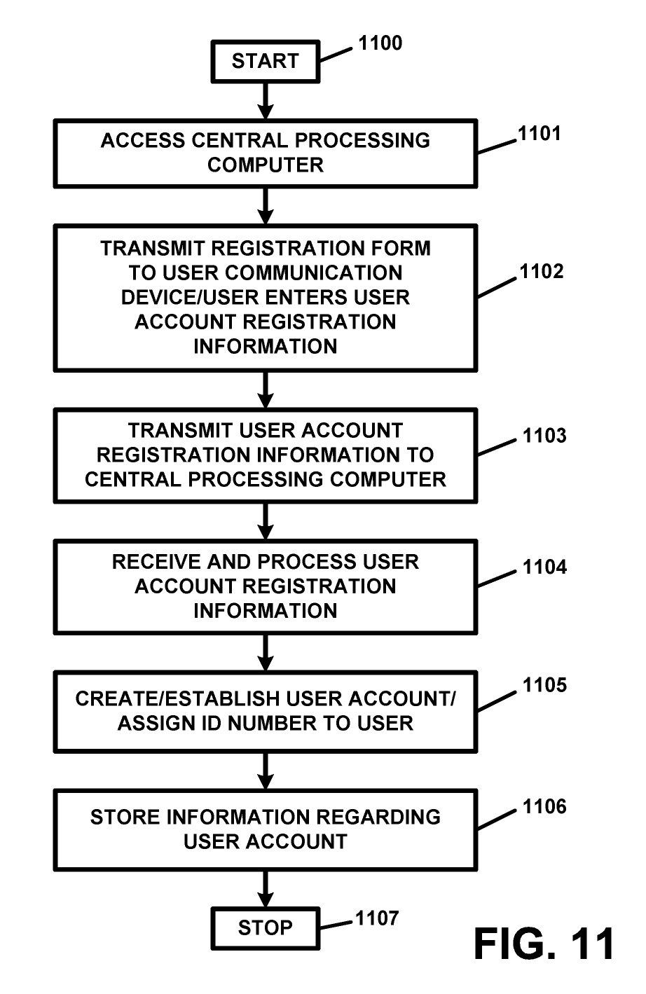

FIG. 11 illustrates a preferred embodiment method for utilizing the apparatus and methods of the present invention, in flow diagram form;

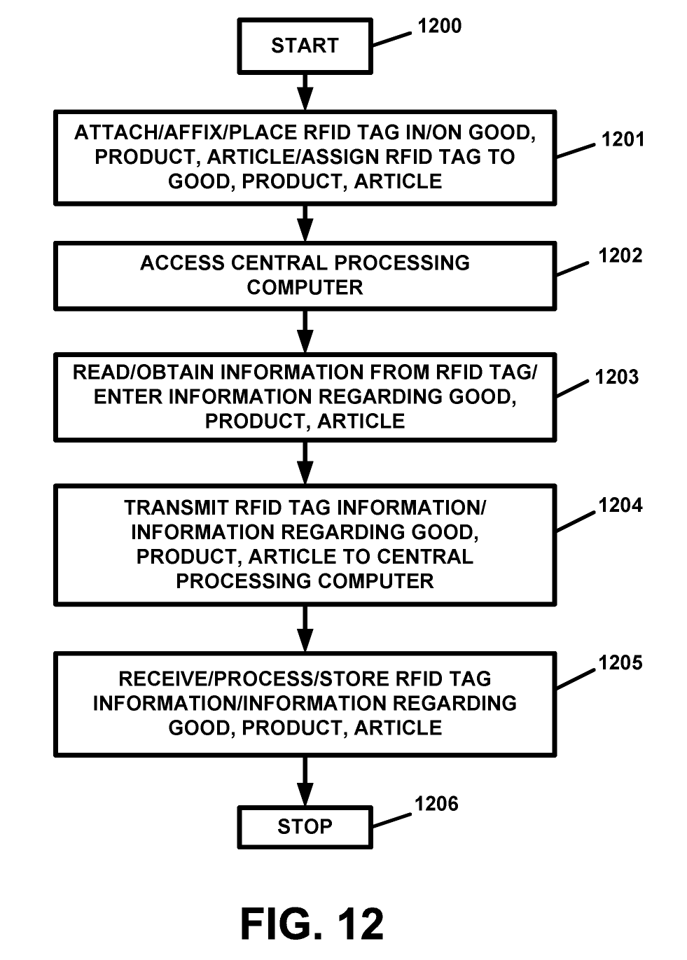

FIG. 12 illustrates another preferred embodiment method for utilizing the apparatus and methods of the present invention, in flow diagram form;

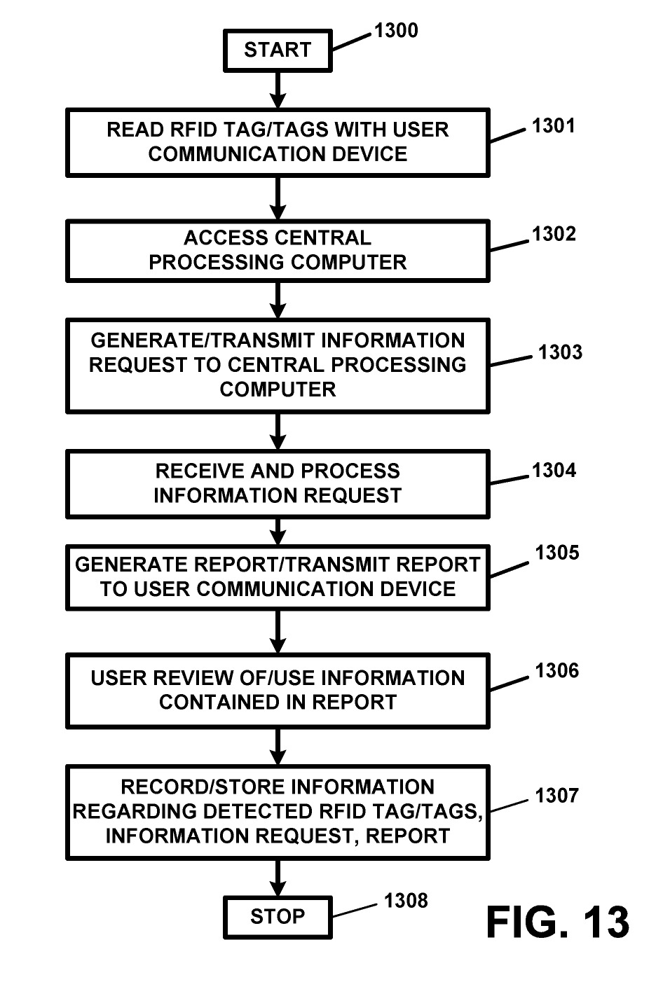

FIG. 13 illustrates still another preferred embodiment method for utilizing the apparatus and methods of the present invention, in flow diagram form; and

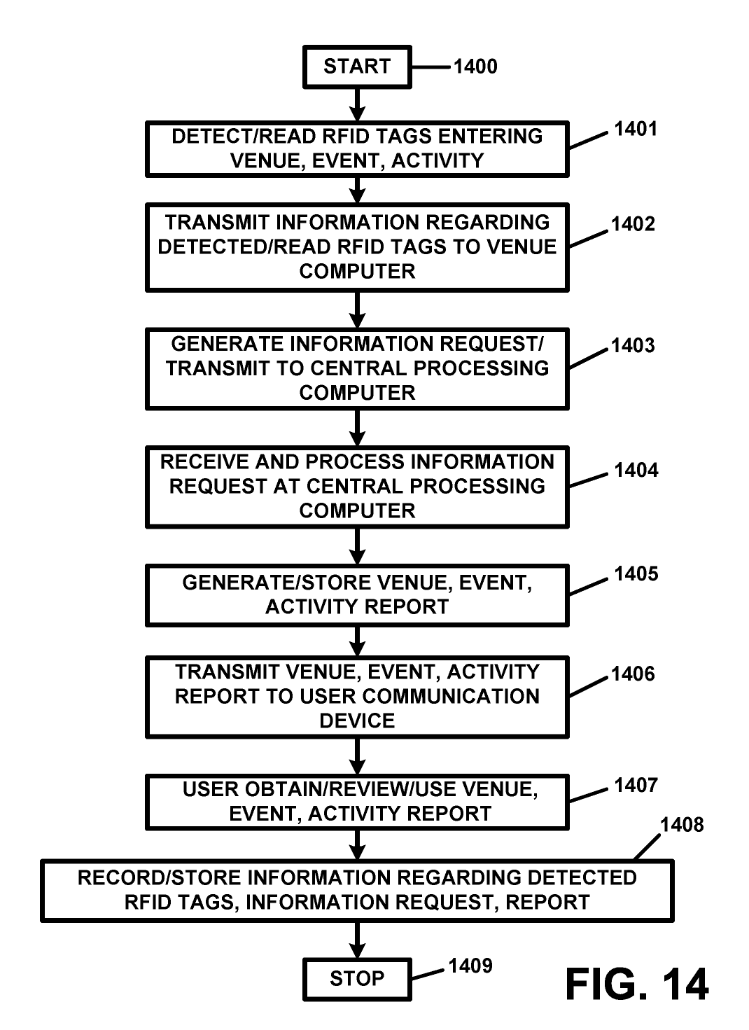

FIG. 14 illustrates another preferred embodiment method for utilizing the apparatus and methods of the present invention, in flow diagram form.

### DESCRIPTION OF THE PREFERRED EMBODIMENTS

The present invention pertains to a radio-frequency identification (RFID) based marketing apparatus and methods and, in particular, to a radio-frequency identification-based marketing apparatus and methods which can be utilized to detect, identify, and provide information regarding, goods, products, or articles, of any type or kind, to individuals or users who come into a close proximity to the same and/or who are, or were, present at a venue, event, or location, where the same is or was located.

In a preferred embodiment, it is envisioned that radio frequency identification (RFID) tags can be attached to, affixed to, or placed on or in, any good, product, or article of commerce. The RFID tag can contain information regarding the respective good, product, or article of commerce, including, for example, but not limited to, the name of the respective good, product, or article of commerce, the manufacturer of same, the brand name of same or the product line of same, the model number of same, a serial number of or for same, a description of same, available sizes for same, a price or prices for same, information identifying one or more retail sellers of same, and/or any other information regarding same such as, for example, but not limited to, information regarding use, cleaning, washing, and/or care, instructions (if applicable). At the time of sale, the RFID tag can be registered to the purchaser of the respective good, product, or article of commerce, if desired.

In a preferred embodiment, once the good, product, or article of commerce, with the RFID tag, is sold and in use, any user or individual or the apparatus and methods of the present invention can, with any suitable RFID reader described herein can, when in proximity to or located near the good, product, or article of commerce, or the person wearing, holding, or utilizing the same, obtain information regarding the respective good, product, or article of commerce, of interest to him or her. Thereafter, the user or individual can use the information obtained via the RFID reader in order to obtain information regarding the respective good, product, or article of commerce, for purposes of identifying the same, obtaining information regarding the same, finding a retail seller of same, and/or simply purchasing the same.

In another preferred embodiment, RFID readers can be utilized at venues for various social, entertainment, sporting, or any other, events and RFID tags can be read as attendees of the respective event enter the respective venue. Thereafter, if a user or individual should see a good, product, or article of commerce, in the crowd or on, worn by, carried by, or being used by a person in attendance, the user or individual can query the list of RFID tags read for the event to find and to identify the respective good, product, or article of commerce, of interest to him or her. Thereafter, the user or individual can use the information obtained in order to obtain information regarding the respective good, product, or article of commerce, for purposes of identifying the same, obtaining information regarding the same, finding a retail seller of same, and/or simply purchasing the same.

In the preferred embodiment of the present invention, the user or individual can obtain information regarding any good, product, or article of commerce, he or she may come across in everyday life situations, provided the good, product, or article of commerce, is equipped with an RFID tag, without having to approach or to speak with the person who is wearing, holding, or using the respective good, product, or article of commerce. In a preferred embodiment, manufacturers, retailers, and marketers, of any types of kinds of goods, products, and/or articles of commerce, can use the apparatus and methods of the present invention to market their goods, products, and/or articles of commerce, via previous purchasers or users of same. Users or individuals who agree to have their name of other identifying information registered along with the RFID tag which is attached to, affixed to, or placed on or in, any good, product, or article of commerce, at the time of purchase, or at any time thereafter, can receive compensation, via an affiliated marketing program, if, and any time or times, their wearing, holding, or use, of the respective good, product, or article of commerce, in a manner which can result in it being read by an RFID reader, results in a purchase by another user or individual of the respective good, product, or article of commerce, or any other good(s), product(s), or article(s) of commerce, sold by the manufacturer, retail seller, or marketer, of the good, product, or article of commerce.

The apparatus and methods of the present invention can be utilized in a wide variety of ways in order to allow manufacturers, retail sellers, and/or marketers, of any types or kinds of goods, products, or articles of commerce, to market the same via previous purchasers or users of same in everyday life situations and/or in other situations.

Applicant hereby incorporates by reference herein the subject matter and teachings of U.S. Provisional Patent Application Ser. No. 62/621,412, filed Jan. 24, 2018, and entitled “RADIO-FREQUENCY IDENTIFICATION (RFID) BASED MARKETING APPARATUS AND METHODS”, the subject matter and teachings of which are hereby incorporated by reference herein in their entirety.

FIG. 1 illustrates a preferred embodiment of the apparatus of the present invention, which is designated by the reference numeral 100, in block diagram form. With reference to FIG. 1, With reference to FIG. 1, the apparatus includes a central processing computer or server computer 10 (hereinafter “central processing computer 10”). The central processing computer 10 can include any number of central processing computers 10 and/or computer systems. In this regard, the central processing computer 10 can be a single computer or server computer or can include a plurality of any number of computers, server computers, or computer systems. In this regard, in any and/or all of the embodiments described herein, the central processing computer 10 can be comprised of one computer or computer system and/or can be comprised of a plurality of computers or computer systems. Any number of central processing computers 10 can be utilized in the apparatus 100 of the present invention.

In the preferred embodiment, the central processing computer 10 is specially programmed and specially configured to perform all of the various operations, functions, and functionalities, described herein as being performed by the same, as well as to perform all of the operations, functions, and functionalities, described herein as being performed by the apparatus 100.

The central processing computer 10, in a preferred embodiment, can be associated with, and/or can used by, any manufacturer(s), wholesaler, retailer, or marketer, of any type or kind of goods, products, or articles of commerce, and/or by any other type or kind of operator.

With reference to FIG. 1, the apparatus 100 also includes any number of user computers or user communication devices 20 (hereinafter “user communication device 20”). The user communication device 20 can be utilized by any user, individual, party, or entity, who or which uses the apparatus 100 of the present invention in order to communicate with the central processing computer(s) 10 described herein and/or to communicate with any of the other computers and communication devices described herein as being utilized in or with the apparatus 100.

In the preferred embodiment, the user communication device 20 can communicate with, and/or can be linked with, the central processing computer(s) 10 and/or any other computers or communication devices described herein, via a wired communication network, a wireless communication network, or via any combination of wired and/or wireless communication networks.

The user communication device 20 can be utilized by any of the herein-described users in order to interface with, and/or interact with, the central processing computer 10 or with any of the other computers and communication devices described herein as being used in or with the apparatus 100. In the preferred embodiment, the user communication device 20 can be a computer, a computer terminal, a terminal device connected to, or associated with, the central processing computer 10, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The user communication device 20 can also be a server computer, a network computer, or any other computer capable of being utilized in a network.

The user communication device 20 can also include and/or can be utilized in conjunction with a network computer or any other computer which can be utilized to send and to receive text messages and/or e-mail messages for or on behalf of a user. The network computer, in the preferred embodiment, can be any computer which can be used in a computer communication network to transmit and/or to receive text messages or e-mail messages to and/or from any of the herein-described user communication devices 20 and/or can provide a text message or an e-mail message to the user communication device 20. In any and/or all of the embodiments described herein, the respective network computer or other computer can also automatically transmit or “push” a text message or an e-mail message or e-mail messages to a user communication device 20 as soon as same are received, in real-time, and/or in any other manner.

In any and/or all of the embodiments described herein, the respective network computer or other computer can also serve as a conventional text message server or as an e-mail server which can allow a user to request or “pull” a text message or an e-mail message or e-mail messages to a user communication device 20 when requested by the user or other authorized individual. In this regard, any network computer or other computer, such as one that can receive and send text messages or email messages to a user communication device 20 is also considered to be a user communication device 20. In this regard, any text message server or any e-mail server can also be deemed to be a user communication device 20. In a preferred embodiment, each user communication device 20 can also have a website or websites associated therewith.

In the preferred embodiment, any number of user communication devices 20 can be utilized in, or in connection with, the apparatus 100. The user communication devices 20 described herein can be utilized to communicate with the central processing computer(s) 10 and/or with any other computers or communication devices described herein in a bi-directional manner.

With reference once again to FIG. 1, the apparatus also includes any number of radio frequency identification (RFID) tags (hereinafter referred to as “RFID tag 30” or “RFID tags 30”), with each RFID tag 30 being attached to, affixed to, or placed on or in, a respective good, product, or article of commerce. The RFID tags 30 can be of any suitable type or kind, and can be selected from among the various types or kinds of RFID tags which are available in the marketplace as of the filing date of this patent application. In a preferred embodiment, the RFID tags 30 can be passive RFID tags, while in other preferred embodiments any one or more of the RFID tags 30 can be active RFID tags. In a preferred embodiment, the RFID tags 30 should be waterproof, washable, and/or otherwise be capable of being cleaned, and they should be temperature resistant and durable, in order to be utilized in connection with, or in conjunction with, all types and/or kinds of clothing or apparel, shoes, boots, hats, gloves, accessories, and other wearable objects and/or articles, as well as in connection with, or in conjunction with, any and/or all types or kinds of goods, products, or articles of commerce. For example, RFID tags which can be used in clothing or apparel applications can be of the type of laundry RFID tags such as those marketed or offered by GAO RFID, Inc. or any other suitable RFID tag manufacturer or distributor. In a preferred embodiment, any type or kind of RFID tag can be utilized in connection with the apparatus 100 of the present invention provided that the respective RFID tag is suitable for use in its particular application. Any number of RFID tags 30 can be utilized in connection with the apparatus 100 of the present invention. Further, in a preferred embodiment, passive RFID tags can be utilized in any situation where a respective tag may not be capable of having its own power source. In embodiments, where RFID tags can be provided with a power source, then active RFID tags can be used. In a preferred embodiment, passive RFID tags can provide for the most convenient use since they do not have or require a power source, but rather, they can be energized and operate when activated by a suitable RFID reader device.

With reference once again to FIG. 1, the apparatus 100 also includes any number of RFID reader systems 40 which can be, or which can include, any suitable RFID reader. In a preferred embodiment, each RFIF reader system 40 can be reader for passive RFID tags or can be a reader for active RFID tags depending upon the application. In a preferred embodiment, each RFIF reader system 40 can be utilized to read any of the RFID tags 30 described herein as being utilized in connection with the apparatus 100 of the present invention.

The RFID reader system 40 can communicate with and/or to interact with the central processing computer(s) 10, the user communication devices 20, and/or with any of the other computers and communication devices described herein as being used in or with the apparatus 100. In the preferred embodiment, the RFID reader system 40 can communicate with, and/or be linked with, the central processing computer(s) 10 and/or any other computer or communication devices described herein, via a wired communication network, a wireless communication network, or via any combination of wired and/or wireless communication networks.

With reference once again to FIG. 1, the apparatus 100 can also include any number of venue computers 50, with each venue computer being assigned to a venue which can be the site of social events, entertainment events, sporting events, or any other events or gatherings, as well as which can be any type or kind of place of business, educational institution, or other public venue. For example, venues can include, but not be limited to stores, places of business, malls, shopping malls, public gathering places, private gathering places, restaurants, cafes, stadiums, arenas, and/or any other place where people can gather for an event or participate in any activity or activities, and/or any other place or location where the apparatus 100 of the present invention can be utilized. In a preferred embodiment, each venue computer 50 can include, be equipped with, or have assigned thereto, an RFID reader or RFID reader systems 40, or any number of RFID readers or RFID reader systems 40. In a preferred embodiment, each venue computer 50 should be equipped with one or more RFID reader or RFID reader systems 40 for reading any of the RFID tags 30 which can enter the respective venue with which the venue computer 50 is associated.

The venue computer 50 can communicate with and/or interact with the central processing computer(s) 10, the user communication devices 20, the RFID reader systems 40, and/or with any of the other computers and communication devices described herein as being utilized in or with the apparatus 100. In the preferred embodiment, the venue computer 50 can communicate with, and/or can be linked with, the central processing computer(s) 10 and/or any other computer or communication devices described herein, via a wired communication network, a wireless communication network, or via any combination of wired and/or wireless communication networks.

The venue computer 50 can also be used by a respective venue in order to interface with, and/or interact with, the central processing computer 10 or with any other computers and communication devices described herein as being used in or with the apparatus 100. In a preferred embodiment, each venue computer 50 can include any number of computers, server computers, or computer systems. In a preferred embodiment, each venue computer 50 can also have a website or websites associated therewith.

With reference once again to FIG. 1, the apparatus 100 can also include any number of manufacturer computers 60, each of which can be associated with and used by any manufacturer which utilizes the apparatus 100 of the present invention. Any number of manufacturer computers 60 can be utilized in connection with the apparatus 100 of the present invention.

The manufacturer computer 60 can communicate with and/or interact with the central processing computer(s) 10, the user communication devices 20, the RFID reader systems 40, and/or with any of the other computers and communication devices described herein as being utilized in or with the apparatus 100. In the preferred embodiment, the manufacturer computer 60 can communicate with, and/or can be linked with, the central processing computer(s) 10 and/or any other computer or communication devices described herein, via a wired communication network, a wireless communication network, or via any combination of wired and/or wireless communication networks.

The manufacturer computer 60 can be used by a respective manufacturer in order to interface with, and/or interact with, the central processing computer 10 or with any other computers and communication devices described herein as being used in or with the apparatus 100. In a preferred embodiment, each manufacturer computer 60 can include any number of computers, server computers, or computer systems. In a preferred embodiment, each manufacturer computer 60 can also have a website or websites associated therewith.

With reference once again to FIG. 1, the apparatus 100 can also include any number of retailer computers 70, each of which can be associated with and used by any retail sellers, retail stores, or on-line retail sellers, which utilizes the apparatus 100 of the present invention. Any number of retailer computers 70 can be utilized in connection with the apparatus 100 of the present invention.

The retailer computer 70 can communicate with and/or interact with the central processing computer(s) 10, the user communication devices 20, the RFID reader systems 40, and/or with any of the other computers and communication devices described herein as being utilized in or with the apparatus 100. In the preferred embodiment, the retailer computer 70 can communicate with, and/or can be linked with, the central processing computer(s) 10 and/or any other computer or communication devices described herein, via a wired communication network, a wireless communication network, or via any combination of wired and/or wireless communication networks.

The retailer computer 70 can be used by a respective retailer in order to interface with, and/or interact with, the central processing computer 10 or with any other computers and communication devices described herein as being used in or with the apparatus 100. In a preferred embodiment, each retailer computer 70 can include any number of computers, server computers, or computer systems. In a preferred embodiment, each retailer computer 70 can also have a web site or web sites associated therewith.

With reference once again to FIG. 1, the apparatus 100 can also include any number of advertiser/marketing entity computers 80, each of which can be associated with and used by any advertiser or marketing entity, of any type or kind, which utilizes the apparatus 100 of the present invention. Any number of advertiser/marketing entity computers 80 can be utilized in connection with the apparatus 100 of the present invention.

The advertiser/marketing entity computer 80 can communicate with and/or interact with the central processing computer(s) 10, the user communication devices 20, the RFID reader systems 40, and/or with any of the other computers and communication devices described herein as being utilized in or with the apparatus 100. In the preferred embodiment, the advertiser/marketing entity computer 80 can communicate with, and/or can be linked with, the central processing computer(s) 10 and/or any other computer or communication devices described herein, via a wired communication network, a wireless communication network, or via any combination of wired and/or wireless communication networks.

The advertiser/marketing entity computer 80 can be used by a respective advertiser or marketing entity in order to interface with, and/or interact with, the central processing computer 10 or with any other computers and communication devices described herein as being used in or with the apparatus 100. In a preferred embodiment, each advertiser/marketing entity computer 80 can include any number of computers, server computers, or computer systems. In a preferred embodiment, each advertiser/marketing entity computer 80 can also have a website or websites associated therewith.

With reference once again to FIG. 1, the apparatus can also include a social network computer 90 which can be used by any social networking company or any social networking provider to provide social networks, social networking services, and/or social networking forums, to, and/or for, any of the users of the apparatus 100 of the present invention. In a preferred embodiment, each social network computer 90 can include any number of computers, server computers, or computer systems.

The social network computer 90 can be utilized by a respective social networking company or a social networking provider associated with the same in order to communicate with and/or to interact with the central processing computer(s) 10, the user communication devices 20, the RFIF system(s) 40, the venue computer(s) 50, the manufacturer computer(s) 60, the retailer computer(s) 70, the advertiser/marketing entity computer(s) 80, and/or any of the other computers and communication devices described herein as being utilized in or with the apparatus 100.

In the preferred embodiment, the social network computer 90 can communicate with, and/or be linked with, the central processing computer(s) 10, any of the user communication devices 20, and/or any other computers or communication devices described herein, via a wired communication network, a wireless communication network, or via any combination of wired and/or wireless communication networks. In a preferred embodiment, the social network computer 90 can transmit information directly to a user communication device 20 or to the central processing computer 10 for re-transmission to a user communication device 20.

In a preferred embodiment, each social network computer 90 can include any number of computers, server computers, or computer systems. In a preferred embodiment, each social network computer 90 can also have a website or websites associated therewith.

With reference once again to FIG. 1, the apparatus 100 also includes a financial institution/intermediary computer or computer system 95 (hereinafter “financial institution computer 95”) which can be used by, and/or which can be associated with a bank or other financial institution for maintaining financial accounts for any of the users, individuals, venues, manufacturers, retailers, advertisers, marketing entities, and/or social networks who of which utilize the apparatus 100 of the present invention.

The financial institution computer 95, in a preferred embodiment, can communicate with and/or can interact with the central processing computer(s) 10, the user communication devices 20, the RFIF system(s) 40, the venue computer(s) 50, the manufacturer computer(s) 60, the retailer computer(s) 70, the advertiser/marketing entity computer(s) 80, and/or any of the other computers and communication devices described herein as being utilized in or with the apparatus 100. In the preferred embodiment, the financial institution computer 95 can communicate with, and/or be linked with, the central processing computer(s) 10, any of the user communication devices 20, and/or any other computers or communication devices described herein, via a wired communication network, a wireless communication network, or any combination of wired and/or wireless communication networks.

In a preferred embodiment, each financial institution computer 95 can include any number of computers, server computers, or computer systems. In a preferred embodiment, each financial institution computer 95 can also have a website or websites associated therewith.

In a preferred embodiment, any of the central processing computer(s) 10, the user communication devices 20, the RFID systems 40, the venue computers 50, the manufacturer computers 60, the retailer computers 70, the advertiser/marketing entity computers 80, the social network computers 90, and/or the financial institution computers 95, can communicate with, transmits data and/or information to, and/or receive data and/or information from, any, or any other, central processing computer(s) 10, the user communication devices 20, the RFID systems 40, the venue computers 50, the manufacturer computers 60, the retailer computers 70, the advertiser/marketing entity computers 80, the social network computers 90, and/or the financial institution computers 95, described herein in a bi-directional manner and/or in any other manner. In this regard, any computer or communication device described herein can communicate, in a bi-directional manner and/or in any other manner, with any other computer or communication device regardless of whether the respective computer or communication device is a central processing computer 10, the user communication device 20, an RFID system 40, a venue computer 50, a manufacturer computer 60, a retailer computer 70, an advertiser/marketing entity computer 80, a social network computer 90, and/or a financial institution computer 95.

In the preferred embodiment, the apparatus 100 and methods of the present invention is utilized on, over, or via, the Internet and/or the World Wide Web. In the preferred embodiment, the apparatus 100 and methods of the present invention can also be utilized over any suitable communication network and/or any combination of computer networks, including, but not limited to the Internet, the World Wide Web, a telecommunication network or system, a telephone network or system, a cable television communication network or system, a satellite television communication network or system, a digital television network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video and communication network or system, a streaming audio communication network or system, a live video communication network or system, and/or any other suitable communications network or system, and/or any combination(s) thereof.

FIG. 2 illustrates the central processing computer 10 of FIG. 1, in block diagram form. With reference to FIG. 2, the central processing computer 10 includes a central processing unit (CPU) 10A. The central processing unit (CPU) 10A may be a microprocessor, a microcomputer, a minicomputer, a macro-computer, or a mainframe computer, depending upon the application. The CPU 10A is specially programmed and/or specially configured to perform all of the functionality described herein as being performed by the central processing computer 10.

The central processing computer 10 also includes a random access memory (RAM) device(s) 10B and a read only memory (ROM) device(s) 10C which are connected to the CPU 10A. The central processing computer 10 also includes a user input device(s) 10D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the central processing computer 10. The user input device(s) 10D is also connected to the CPU 10A. In a preferred embodiment, data, information, instructions, or commands, can also be input using voice a microphone as an input device and recognition software.

The central processing computer 10 also includes a display device 10E, such as a display monitor and/or a display screen, for providing the herein-described data and/or information to the operator or user of the central processing computer 10. The display device 10E is also connected to the CPU 10A.

The central processing computer 10 can also include an output device(s) 10F, such as a printer, a display device, and/or a modem, for outputting, in either or both of hard copy form or electronic form, any of the data and/or information which is described herein as being provided by, from, or at, the central processing computer 10. The output device(s) 10F can also be connected to the CPU 10A.

The central processing computer 10 can also include a receiver 10G for receiving data and/or information, including any of the herein-described data and/or information, and/or any of the other data and/or information described herein as being provided to, or transmitted to, the central processing computer 10 from any of the herein-described user communication devices 20, RFID reader systems 40, venue computers 50, manufacturer computers 60, retailer computers 70, advertiser/marketing entity computers 80, social network computers 90, and/or financial institution computers 95, or from any of the other central processing computers 10.

The central processing computer 10 also includes a database(s) 10H, which is also connected to or linked with the CPU 10A. The database 10H can contain and/or include any and/or all of the data and/or information needed or desired for performing any and/or all of the functions and/or functionality described herein as being performed by the central processing computer 10 and/or the apparatus 100 and methods of the present invention.

In a preferred embodiment, the database 10H can contain and/or include data and/or information regarding any of the herein-described users or individuals who or which use to the apparatus 100 and methods of the present invention, and/or any data and/or information regarding any of the herein-described venues, manufacturers, retailers, advertisers or marketing entities, social networks, and/or financial institutions, who or which utilize the apparatus 100 and methods of the present invention.

In a preferred embodiment, the database 10H can contain and/or include data and/or information for each user or individual who utilize the apparatus and methods of the present invention, including, but not limited to, the user's or individual's name, address, telephone number, email address, cellular or wireless telephone number, text messaging, SMS messaging, or instant messaging, number, website address, uniform resource locator (“url”), and/or any other identification and/or contact data and/or information regarding the user or individual. The database 10H can also contain and/or include, for each user or individual, data and/or information regarding the user's gender, age, demographics, race, religion, nationality, education level or education information, educational history or information, occupation, employment information, information regarding the user's employer, and/or information regarding any members of the user's household or family, and/or social networking friends, followers, or other individuals. The database 10H can also contain and/or include, for each user or individual, data and/or regarding the user's or individual's purchasing history, purchasing interests, buying habits, past purchases made, future purchases they have indicated they may desire to make, and/or any other information regarding the user or individual that may be of interest to any of the herein-described venues, manufacturers, retailers, advertiser or marketing entities, social networks, and/or financial institutions, described herein.

The database 10H can also contain and/or include data and/or information regarding each RFID tag 30 which is registered to the user or individual, including the RFID tag identification number or other identification information for and/or regarding, or associated with, the RFID tag 30. In a preferred embodiment, the database 10H can also contain and/or include, for each RFID tag 30, data and/or information regarding the manufacturer and the model number of the RFID tag 30, information regarding the type of RFID tag, such as, for example, whether the RFID tag 30 is a passive tag or an active tag, information regarding use limitations of the RFID tag 30, such as, but not limited to, whether or not the RFID tag 30 is waterproof, washable, cleanable, or requires maintenance, information regarding use instructions or care instructions regarding the RFID tag 30, and/or any other data and/or information pertinent to the RFID tag 30.

The database 10H can also contain and/or include, for each RFID tag 30 which is registered to the user or individual, data and/or information regarding each good, product, or article of commerce, on, in, or with, which the RFID is being used or to which the RFID tag 30 is assigned, and for each respective good, product, or article of commerce, the database 10H can contain and/or include data and/or information regarding the good, product, or article of commerce, including, but not limited, an identification of the respective good, product, or article, and data and/or information regarding a name, generic description of, detailed description of, use instructions, care instructions, washing or cleaning instructions, available sizes, available colors, available models, model numbers, prices, warranty information, inventory numbers, available inventory, and/or any other data and/or information regarding the respective good, product, or article, which may be of interest to any users, individuals, venues, manufacturers, retailers, advertisers, marketing entities, social networks, or financial institutions, who of which utilize the apparatus 100 of the present invention.

The database 10H can contain and/or include data and/or information regarding all goods, products, and/or articles of commerce, which are manufactured and/or sold by any manufacturers or retail sellers which utilize the apparatus 100. The database 10H can contain and/or include, for each good, product, or article of commerce, data and/or information regarding a name or brand name of same, the product line of same, a generic description of same, a detailed description of same, the model number of same, available models of same, a serial number of or for same, available sizes for same, available colors for same, a price or prices for same, information identifying one or more retail sellers of same, information regarding sales, discounts, sales coupons, discount coupons, or manufacturer rebates for same, and/or any other information regarding use instructions, care instructions, and/or washing or cleaning instructions, for same (if applicable). The database 10H can also contain and/or include, for each good, product, or article of commerce, data and/or information regarding warranty information, inventory information, available inventory, and/or any other data and/or information regarding the respective good, product, or article, which may be of interest to any users, individuals, venues, manufacturers, retailers, advertisers, marketing entities, social networks, or financial institutions, who of which utilize the apparatus 100 of the present invention.

The database 10H can contain and/or include, for each good, product, or article of commerce, data and/or information regarding the RFID tag 30 which is attached to, affixed to, or placed on or in the respective good, product, or article of commerce.

The database 10H can also contain and/or include, for each good, product, or article of commerce, data and/or information regarding manufacturing date(s), production date(s), manufacturing time(s), production time(s), manufacturing location, production location, manufacturing or production batch number, lot number, and/or any other information, for or regarding any of the good, product, or article. In a preferred embodiment, any data and/or information regarding manufacturing date(s), production date(s), manufacturing time(s), production time(s), manufacturing location, production location, manufacturing or production batch number, lot number, and/or any other information, for or regarding any good, product, or article, can be utilized to document goods, products, or articles, purchased by any user or individual and can also be utilized to provide an alert message(s) or a notification message(s) when a good, product, or article, might be available for sale, might be on back-order, and/or be might the subject of a recall of any type or kind.

The database 10H can also contain and/or include, for each good, product, or article of commerce, data and/or information regarding manufacturing date(s), production date(s), manufacturing time(s), production time(s), manufacturing location, production location, manufacturing or production batch number, lot number, and/or any other information, for or regarding any of the good, product, or article. In a preferred embodiment, any data and/or information regarding manufacturing date(s), production date(s), manufacturing time(s), production time(s), manufacturing location, production location, manufacturing or production batch number, lot number, and/or any other information, for or regarding any good, product, or article, can be utilized to document goods, products, or articles, purchased by and user or individual can also be utilized to provide an alert message(s) or a notification message(s) when a good, product, or article, might be available for sale, might be on back-order, and/or be might the subject of a recall of any type or kind.

The database 10H can also contain and/or include, for each RFID Reader or for each venue computer 50 utilized in connection with the apparatus 100 of the present invention, data and/or information regarding the name or identification of the respective RFID Reader or venue computer 50, information regarding the owner and/or operator of same, including the owner's or operator's name, address, telephone number, email address, text, SMS, or instant messaging, number, website address, and/or any other identifying and/or contact information for the owner and/or operator. The database 10H can also contain and/or include, for each RFID Reader or for each venue computer 50, data and/or information regarding the manufacturer and model number of the RFID reader or the venue computer 50, information regarding the type of RFID reader utilized in same, such as, for example, whether the RFID reader is a passive RFID tag reader or an active RFID tag reader. The database 10H can also contain and/or include, for each RFID reader or for each Venue computer 50, a listing of all RFID tags 30 previously read by the respective RFID reader or for each Venue computer 50 as well as any of the herein-described data and/or information regarding any respective goods, products, or articles of commerce, associated with any previously read RFID tags 30, including any of the data and/or information regarding any goods, products, or articles of commerce, described herein as being stored or processed by the apparatus 100, the central processing computer 10, or any of the herein-described computers or communication devices.

The database 10H can also contain and/or include, for each venue which utilizes the apparatus 100 and methods of the present invention, data and/or information regarding the name, address, telephone number, email address, text, SMS, or instant messaging, number, website address, url, and/or any other identifying and/or contact information for the venue. The database 10H can also contain and/or include, for each venue, a calendar or schedule of events for or at the venue, a description of each event, and, for events which have occurred, the date of same, presenters and/or sponsors of same, attendees of the same, and all RFID tags 30 detected and/or identified from among those individuals attending the event at the venue. The database 10H can also contain and/or include, for each RFID tag 30 detected at an event, data and/or information obtained from the detected RFID tag 30 regarding the good, product, or article of commerce, to which the RFID tag 30 is associated. Data and/or information regarding the good, product, or article of commerce, to which the RFID tag 30 is associated can include, but not be limited to, a name, generic description of, detailed description of, use instructions, care instructions, washing or cleaning instructions, available sizes, available colors, available models, model numbers, prices, warranty information, inventory numbers, available inventory, and/or any other data and/or information regarding the respective good, product, or article, which may be of interest to any users, individuals, venues, manufacturers, retailers, advertisers, marketing entities, social networks, or financial institutions, who of which utilize the apparatus 100 of the present invention.

For each respective manufacturer, retailer, advertiser, and/or marketing entity, which utilizes the apparatus 100 of the present invention, the database 10H can contain and/or include data and/or information regarding the name, address, telephone number, email address, cellular or wireless telephone number, text messaging, SMS messaging, or instant messaging, number, website address, url, and/or any other identification and/or contact data and/or information regarding the respective manufacturer, retailer, advertiser, and/or marketing entity. For each respective manufacturer, retailer, advertiser, and/or marketing entity, which utilizes the apparatus 100 of the present invention, the database 10H can contain and/or include data and/or information regarding the respective good(s), product(s), or article(s) of commerce, manufactured, sold, advertised, and/or marketed by, the respective manufacturer, retailer, advertiser, and/or marketing entity. For each good, product, or article of commerce, manufactured, sold, advertised, and/or marketed by, the respective manufacturer, retailer, advertiser, and/or marketing entity, the database 10H can contain and/or include data and/or information regarding the name, generic description of, detailed description of, use instructions, care instructions, washing or cleaning instructions, available sizes, available colors, available models, model numbers, prices, warranty information, inventory numbers, available inventory, and/or any other data and/or information for or regarding the respective good, product, or article.

The database 10H can also contain and/or include, for any social network or social networks which utilize the apparatus 100 and methods of the present invention, data and/or information regarding the name, address, telephone number, email address, cellular or wireless telephone number, text messaging, SMS messaging, or instant messaging, number, website address, url, and/or any other identification and/or contact data and/or information regarding the respective social network along with data and/or information regarding any members of the respective social network.

The database 10H can also contain and/or include, for any financial institution or financial institutions which utilize the apparatus 100 and methods of the present invention, data and/or information regarding the name, address, telephone number, email address, cellular or wireless telephone number, text messaging, SMS messaging, or instant messaging, number, website address, url, and/or any other identification and/or contact data and/or information regarding the respective financial institution along with data and/or information, described herein or otherwise, regarding any of the herein-described users, individuals, RFID reader or RFID reader system owners or operators, venues, manufacturers, retailers, advertisers, marketing entities, and/or social networks, who or which have or hold accounts with the respective financial institution along with data and/or information regarding each account.

The database 10H can also contain and/or include any data and/or information described herein as being contained and/or included in any of the herein-described and respective databases for each of the user communication devices 20, the RFID reader systems 40, the venue computers 50, the manufacturer computers 60, the retailer computers 70, the advertiser/marketing entity computers 80, the social network computers 90, and/or the financial institution computers 95, described herein as being utilized in connection, and/or in conjunction with, the apparatus 100 of the present invention.

In a preferred embodiment, the database 10H can also contain and/or include, any other data and/or information and/or any link(s) or hyperlink(s) to same, described herein as being utilized in connection with the apparatus 100 and method of the present invention.

In a preferred embodiment, the database 10H can also contain and/or include any data, information, software program(s), software, software application(s), or software “app” or “apps”, needed or desired for performing any of the operations, functions, and/or functionality, described herein as being performed by any and/or all of the central processing computer 10, the apparatus 100, the user communication devices 20, the RFID reader systems 40, the venue computers 50, the manufacturer computers 60, the retailer computers 70, the advertiser/marketing entity computers 80, the social network computers 90, and/or the financial institution computers 95, described herein.

In a preferred embodiment, the database 10H can also contain and/or include, any data and/or information, and/or software or software programs or software applications or “apps” for performing a language translation of any text or audio information provided via the apparatus 100 of the present invention from one language to another.

In a preferred embodiment, the database 10H can also contain and/or include any and/or all of the data and/or information described herein as being stored in the respective databases of any of the herein-described central processing computer(s) 10, user communication devices 20, RFID reader systems 40, venue computers 50, manufacturer computers 60, retailer computers 70, advertiser/marketing entity computers 80, social network computers 90, and/or financial institution computers 95.

The central processing computer 10 can also include a transmitter 10I for transmitting data and/or information, including any of the herein-described data and/or information, and/or any other data and/or information described herein as being provided by, from, or to, the central processing computer 10, to any of the user communication devices 20, RFID reader systems 40, venue computers 50, manufacturer computers 60, retailer computers 70, advertiser/marketing entity computers 80, social network computers 90, and/or financial institution computers 95, or to any of the other central processing computer 10. The transmitter 10I can also be connected to the CPU 10A.

With reference to FIG. 2, the central processing computer 10 can also include a global positioning device 10J for determining the position or location of the central processing computer 10. In a preferred embodiment, the global positioning device 10J can be utilized in order to determine the position or location of the central processing computer 10.

The central processing computer 10 can also include a video and/or audio recording device(s) 10K which can include a camera and/or a video recording device for recording pictures or video and/or video clips and/or a microphone or an audio recording device for recording audio or audio clips which can be recorded by, and/or transmitted live, by or from the central processing computer 10, or which can be recorded by, and stored at or in, the central processing computer 10 for transmission by or from the central processing computer 10 at a later time. The video and/or audio recording device(s) 10K can also be utilized to facilitate one-way broadcasts from the central processing computer 10, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the central processing computer 10 can engage in telephone calls and video conferencing calls via the same. The user or operator of the central processing computer 10 can also use the video and/or audio recording device(s) 10K to record and broadcast or transmit content via its transmitter 10I.

FIG. 3 illustrates the user communication device 20 of FIG. 1, in block diagram form. With reference to FIG. 3, in the preferred embodiment, the user communication device 20 includes a central processing unit or CPU 20A which, in the preferred embodiment, is a microprocessor. The CPU 20A may also be a microcomputer, a minicomputer, a macro-computer, and/or a mainframe computer, depending upon the application. The CPU 20A is specially programmed and/or specially configured to perform any and/or all of the functionality described herein as being performed by the user communication device 20.

The user communication device 20 also includes a random access memory (RAM) device(s) 20B and a read only (ROM) memory device(s) 20C, each of which is connected to the CPU 20A, and a user input device(s) 20D, for entering data or information and/or instructions and/or commands into the user communication device 20. The user input device(s) 20D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the user communication device 20. The user input device(s) 20D is/are also connected to the CPU 20A.

The user communication device 20 also includes a display device 20E for displaying data and/or information to a user. The user communication device 20 also includes a transmitter 20F, for transmitting signals and/or data and/or information to any one or more of the central processing computers 10, the RFID reader systems 40, the venue computers 50, the manufacturer computers 60, the retailer computers 70, the advertiser/marketing entity computers 80, the social network computers 90, and/or the financial institution computers 95, or to any of the other user communication devices 20.

The user communication device 20 also includes a receiver 20G, for receiving signals and/or data and/or information from any one or more of the central processing computers 10, the RFID reader systems 40, the venue computers 50, the manufacturer computers 60, the retailer computers 70, the advertiser/marketing entity computers 80, the social network computers 90, and/or the financial institution computers 95, or from any of the other user communication devices 20.

The user communication device 20 also includes a database(s) 20H. The database 20H can contain and/or be linked to any of the data and/or information described herein as being stored in the database 10H. The database 20H can also contain and/or include any data and/or information regarding the user or individual who or which utilizes the user communication device 20, and for each user or individual, the database 20H can contain and/or include, but not be limited to, data and/or information regarding the user's or individual's, or each user's or individual's name, address, telephone number (s), cellular telephone number(s), mobile or wireless telephone number(s), e-mail address or e-mail addresses, and/or text message, instant message, SMS message, or MMS message, or any other messaging, telephone number or other address or identifier.

The database 20H can also contain and/or include any data and/or information regarding any RFID tags 30 which are, or which have been, registered to the user or individual along with any of the herein-described information regarding any good, product, or article of commerce, which is associated with the RFID tag 30 or on, or in, which the RFID tag 30 is attached, affixed, or included.

The database 20H can also contain data and/or information regarding any accounts the user or individual has or holds with any of the herein-described venues, manufacturers, retailers, advertisers, marketing entities, social networks, and/or financial institutions.

The database 20H can also contain and/or include any data and/or information described herein as being contained and/or included in any of the herein-described and respective databases for each of the central processing computer(s) 10, the RFID reader systems 40, the venue computers 50, the manufacturer computers 60, the retailer computers 70, the advertiser/marketing entity computers 80, the social network computers 90, and/or the financial institution computers 95, described herein as being utilized in connection, and/or in conjunction with, the apparatus 100 of the present invention.

The database 20H can also contain and/or include any data and/or information which may be required, and/or which may be desired, for performing any of the functionality and/or processing routines described herein as being performed by the user communication device 20 and/or the apparatus 100. The database 20H can also be connected to the CPU 20A.

The user communication device 20 also includes an output device(s) 20I for outputting any of the data and/or information described herein as being generated by or via the user communication device 20. In the preferred embodiment, the output device(s) 20I can be a printer, a display, a transmitter, a modem, and/or any other device which can be used to output data or information of any kind or type. The output device(s) 20I can also be connected to the CPU 20A.

The user communication device 20 also includes a video and/or audio recording device(s) 20J which can include a camera and/or a video recording device for recording pictures or video and/or video clips and/or a microphone or an audio recording device for recording audio or audio clips which can be recorded by, and/or transmitted live, by or from the user communication device 20, or which can be recorded by, and stored at or in, the user communication device 20 for transmission by or from the user communication device 20 at a later time. The video and/or audio recording device(s) 20J can also be utilized to facilitate one-way broadcasts from the user communication device 20, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the user communication device 20 can engage in telephone calls and video conferencing calls via the same. The user of the user communication device 20 can also use the video and/or audio recording device(s) 20J to record and broadcast or transmit content via its transmitter 20F. The video and/or audio recording device(s) 20J can also be connected to the CPU 20A.

With reference to FIG. 3, the user communication device 20, in the preferred embodiment, also includes a global positioning device 20K for determining the position or location of the user communication device 20. The global positioning device 20K can also be connected to the CPU 20A.

With reference to FIG. 3, the user communication device 20, in the preferred embodiment, can also include an RFID reader 20L which can be any commercially available RFID reader device, available in the marketplace at the time of the filing of this patent application, and which can be suitable for use with the kind or type of user communication device 20 which is utilized. As an for at least one example, in a preferred embodiment wherein the user communication device 20 is a cellular telephone, smart phone, personal digital assistant, and/or any other handheld, portable, or wearable, device, the RFID reader can be any suitable and commercially available RFID reader which can be integrated with the respective user communication device 20, can be integrated into a case or other housing of and/or for the respective user communication device 20, or can be located externally from and/or can be wirelessly linked to or with, the respective user communication device 20 and/or the CPU 20A of same, such as by using any suitable wireless communication technology and/or a Bluetooth communication link. In such an embodiment, the user communication device 20 can be programmed with or equipped with any suitable hardware and software programs or software applications (“apps”) needed or desired for enabling the user communication device 20 and the RFID reader 20L to communicate with each other and work together to provide the respective user communication device 20 with RFID reading capabilities and functionalities.

FIG. 4 illustrates the RFID reader system 40 of FIG. 1, in block diagram form. With reference to FIG. 4, in the preferred embodiment, the RFID reader system 40 includes a central processing unit or CPU 40A which, in the preferred embodiment, is a microprocessor. The CPU 40A may also be a microcomputer, a minicomputer, a macro-computer, and/or a mainframe computer, depending upon the application. The CPU 40A is specially programmed and/or specially configured to perform any and/or all of the functionality described herein as being performed by the RFID reader system 40.

The RFID reader system 40 also includes a random access memory (RAM) device(s) 40B and a read only (ROM) memory device(s) 40C, each of which is connected to the CPU 40A, and a user input device(s) 40D, for entering data or information and/or instructions and/or commands into the RFID reader system 40. The user input device(s) 40D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the RFID reader system 40. The user input device(s) 40D is/are also connected to the CPU 40A.

The RFID reader system 40 also includes a display device 40E for displaying data and/or information to a user. The RFID reader system 40 also includes a transmitter 40F, for transmitting signals and/or data and/or information to any one or more of the central processing computers 10, the user communication devices 20, the venue computers 50, the manufacturer computers 60, the retailer computers 70, the advertiser/marketing entity computers 80, the social network computers 90, and/or the financial institution computers 95, or to any of the other RFID reader systems 40.

The RFID reader system 40 also includes a receiver 40G, for receiving signals and/or data and/or information from any one or more of the central processing computers 10, the user communication devices 20, the venue computers 50, the manufacturer computers 60, the retailer computers 70, the advertiser/marketing entity computers 80, the social network computers 90, and/or the financial institution computers 95, or from any of the other RFID reader systems 40.

The RFID reader system 40 also includes a database(s) 40H. The database 40H can contain and/or be linked to any of the data and/or information described herein as being stored in the database 10H. The database 40H can also contain and/or include any data and/or information regarding any RFID tags 30 which are, or which have been, read by the RFID reader system 40, any user(s) or individual(s) registered to each respective RFID tag 30, any respective good, product, or article of commerce, associated with the respective RFID tag 30 or to, on, or in, which the RFID tag 30 is attached, affixed, or included, and any other data and/or information which may be needed and/or desired for the operation and/or functioning of the RFID reader system 40.

The database 40H can also contain data and/or information regarding any accounts the user or individual has or holds with any of the herein-described venues, manufacturers, retailers, advertisers, marketing entities, social networks, and/or financial institutions.

The database 40H can also contain and/or include any data and/or information described herein as being contained and/or included in any of the herein-described and respective databases for each of the central processing computer(s) 10, the user communication devices 20, the venue computers 50, the manufacturer computers 60, the retailer computers 70, the advertiser/marketing entity computers 80, the social network computers 90, and/or the financial institution computers 95, described herein as being utilized in connection, and/or in conjunction with, the apparatus 100 of the present invention.

The database 40H can also contain and/or include any data and/or information which may be required, and/or which may be desired, for performing any of the functionality and/or processing routines described herein as being performed by the RFID reader system 40 and/or the apparatus 100. The database 40H can also be connected to the CPU 40A.

The RFID reader system 40 also includes an output device(s) 40I for outputting any of the data and/or information described herein as being generated by or via the RFID reader system 40. In the preferred embodiment, the output device(s) 40I can be a printer, a display, a transmitter, a modem, and/or any other device which can be used to output data or information of any kind or type. The output device(s) 40I can also be connected to the CPU 40A.

The RFID reader system 40 can also include a video and/or audio recording device(s) 40J which can include a camera and/or a video recording device for recording pictures or video and/or video clips and/or a microphone or an audio recording device for recording audio or audio clips which can be recorded by, and/or transmitted live, by or from the RFID reader system 40, or which can be recorded by, and stored at or in, the RFID reader system 40 for transmission by or from the RFID reader system 40 at a later time. The video and/or audio recording device(s) 40J can also be utilized to facilitate one-way broadcasts from the RFID reader system 40, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the RFID reader system 40 can engage in telephone calls and video conferencing calls via the same. The user or operator of the RFID reader system 40 can also use the video and/or audio recording device(s) 40J to record and broadcast or transmit content via its transmitter 40F. The video and/or audio recording device(s) 40J can also be connected to the CPU 40A.

With reference to FIG. 4, the RFID reader system 40, in the preferred embodiment, also includes a global positioning device 40K for determining the position or location of the RFID reader system 40. The global positioning device 40K can also be connected to the CPU 40A.

With reference to FIG. 4, the RFID reader system 40, in the preferred embodiment, can also include an RFID reader 40L which can be any commercially available RFID reader device which can be suitable for use with the kind or type of RFID reader system 40 which is utilized. The RFID reader can be any suitable and commercially available RFID reader which can be integrated with the respective RFID reader system 40, can be integrated into a case or other housing of and/or for the respective RFID reader system 40, or can be located externally from and/or can be wirelessly linked to or with, the respective RFID reader system 40 and/or the CPU 40A of same, such as by using any suitable wireless communication technology and/or a Bluetooth communication link. In such an embodiment, the RFID reader system 40 can be programmed with or equipped with any suitable hardware and software programs or software applications (“apps”) needed or desired for enabling the RFID reader system 40 and the RFID reader 40L to communicate with each other and work together to provide the respective RFID reader system 40 with all necessary or desired RFID reading capabilities and functionalities.

FIG. 5 illustrates the venue computer 50 of FIG. 1, in block diagram form. With reference to FIG. 5, in the preferred embodiment, the venue computer 50 includes a central processing unit or CPU 50A which, in the preferred embodiment, is a microprocessor. The CPU 50A may also be a microcomputer, a minicomputer, a macro-computer, and/or a mainframe computer, depending upon the application. The CPU 50A is specially programmed and/or specially configured to perform any and/or all of the functionality described herein as being performed by the venue computer 50.

The venue computer 50 also includes a random access memory (RAM) device(s) 50B and a read only (ROM) memory device(s) 50C, each of which is connected to the CPU 50A, and a user input device(s) 50D, for entering data or information and/or instructions and/or commands into the venue computer 50. The user input device(s) 50D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the venue computer 50. The user input device(s) 50D is/are also connected to the CPU 50A.

The venue computer 50 also includes a display device 50E for displaying data and/or information to a user. The venue computer 50 also includes a transmitter 50F, for transmitting signals and/or data and/or information to any one or more of the central processing computers 10, the user communication devices 20, the RFID reader systems 40, the manufacturer computers 60, the retailer computers 70, the advertiser/marketing entity computers 80, the social network computers 90, and/or the financial institution computers 95, or to any of the other venue computers 50.

The venue computer 50 also includes a receiver 50G, for receiving signals and/or data and/or information from any one or more of the central processing computers 10, the user communication devices 20, the RFID reader systems 40, the manufacturer computers 60, the retailer computers 70, the advertiser/marketing entity computers 80, the social network computers 90, and/or the financial institution computers 95, or from any of the other venue computers 50.

The venue computer 50 also includes a database(s) 50H. The database 50H can contain and/or be linked to any of the data and/or information described herein as being stored in the database 10H. The database 50H can also contain and/or include any data and/or information regarding the venue associated with the respective venue computer 50, and/or data and/or information regarding the name, address, telephone number, email address, text, SMS, or instant messaging, number, website address, url, and/or any other identifying and/or contact information for the venue. The database 50H can also contain and/or include, for the venue associated with the respective venue computer 50, a calendar or schedule of events for or at the venue, a description of each event, and, for events which have occurred, the date of the same, presenters and/or sponsors of same, attendees of the same, and all RFID tags 30 detected and/or identified from among those individuals attending the event at the venue.

The database 50H can also contain and/or include, for each RFID tag 30 detected and/or identified at an event, data and/or information obtained from the detected RFID tag 30 regarding the good, product, or article of commerce, to which the RFID tag 30 is associated. Data and/or information regarding the good, product, or article of commerce, to which the RFID tag 30 is associated, can include, but not be limited to, a name, generic description of, detailed description of, use instructions, care instructions, washing or cleaning instructions, available sizes, available colors, available models, model numbers, prices, warranty information, inventory numbers, available inventory, and/or any other data and/or information regarding the respective good, product, or article, which may be of interest to any users, individuals, venues, manufacturers, retailers, advertisers, marketing entities, social networks, or financial institutions, who of which utilize the apparatus 100 of the present invention.

The database 50H can also contain data and/or information regarding any accounts the user or individual has or holds with the venue. The database 50H can also contain and/or include any other data and/or information which is needed or desired foe enabling the venue computer 50 to perform all of the operations and functions described herein as being capable of being performed by the venue computer and/or the apparatus 100.

The database 50H can also contain and/or include any data and/or information described herein as being contained and/or included in any of the herein-described and respective databases for each of the central processing computer(s) 10, the user communication devices 20, the RFID reader systems 40, the manufacturer computers 60, the retailer computers 70, the advertiser/marketing entity computers 80, the social network computers 90, and/or the financial institution computers 95, described herein. The database 50H can also be connected to the CPU 50A.

The venue computer 50 also includes an output device(s) 50I for outputting any of the data and/or information described herein as being generated by or via the venue computer 50. In the preferred embodiment, the output device(s) 50I can be a printer, a display, a transmitter, a modem, and/or any other device which can be used to output data or information of any kind or type. The output device(s) 50I can also be connected to the CPU 50A.

The venue computer 50 can also include a video and/or audio recording device(s) 50J which can include a camera and/or a video recording device for recording pictures or video and/or video clips and/or a microphone or an audio recording device for recording audio or audio clips which can be recorded by, and/or transmitted live, by or from the venue computer 50, or which can be recorded by, and stored at or in, the venue computer 50 for transmission by or from the venue computer 50 at a later time. The video and/or audio recording device(s) 50J can also be utilized to facilitate one-way broadcasts from the venue computer 50, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the venue computer 50 can engage in telephone calls and video conferencing calls via the same. The user or operator of the venue computer 50 can also use the video and/or audio recording device(s) 50J to record and broadcast or transmit content via its transmitter 50F. The video and/or audio recording device(s) 50J can also be connected to the CPU 50A.

With reference to FIG. 5, the venue computer 50, in the preferred embodiment, also includes a global positioning device 50K for determining the position or location of the venue computer 50. The global positioning device 50K can also be connected to the CPU 50A.

With reference to FIG. 5, the venue computer 50, in the preferred embodiment, can also include on or more RFID readers 50L which can be any commercially available RFID reader device(s) which can be suitable for use with the kind or type of venue computer 50 which is utilized and the particular RFID reading functionality required at the venue. In a preferred embodiment, one or more RFID readers 50L can be stationed at, or positioned, at venue entrances in order for the respective RFID readers to read RFID tags 30 which are attached to or affixed to, or which are placed on or in, goods, products, or articles of commerce, pass by the same as the individuals, who are wearing, or who have, goods, products, or articles of commerce, equipped with RFID tags 40 enter into or onto the venue.

FIG. 6 illustrates the manufacturer computer 60 of FIG. 1, in block diagram form. With reference to FIG. 6, in the preferred embodiment, the manufacturer computer 60 includes a central processing unit or CPU 60A which, in the preferred embodiment, is a microprocessor. The CPU 60A may also be a microcomputer, a minicomputer, a macro-computer, and/or a mainframe computer, depending upon the application. The CPU 60A is specially programmed and/or specially configured to perform any and/or all of the functionality described herein as being performed by the manufacturer computer 60.

The manufacturer computer 60 also includes a random access memory (RAM) device(s) 60B and a read only (ROM) memory device(s) 60C, each of which is connected to the CPU 60A, and a user input device(s) 60D, for entering data or information and/or instructions and/or commands into the manufacturer computer 60. The user input device(s) 60D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the manufacturer computer 60. The user input device(s) 60D is/are also connected to the CPU 60A.

The manufacturer computer 60 also includes a display device 60E for displaying data and/or information to a user. The manufacturer computer 60 also includes a transmitter 60F, for transmitting signals and/or data and/or information to any one or more of the central processing computers 10, the user communication devices 20, the RFID reader systems 40, the venue computers 50, the retailer computers 70, the advertiser/marketing entity computers 80, the social network computers 90, and/or the financial institution computers 95, or to any of the other manufacturer computers 60.

The manufacturer computer 60 also includes a receiver 60G, for receiving signals and/or data and/or information from any one or more of the central processing computers 10, the user communication devices 20, the RFID reader systems 40, the venue computers 40, the retailer computers 70, the advertiser/marketing entity computers 80, the social network computers 90, and/or the financial institution computers 95, or from any of the other manufacturer computers 60.

The manufacturer computer 60 also includes a database(s) 60H. The database 60H can contain and/or be linked to any of the data and/or information described herein as being stored in the database 10H. The database 60H can also contain and/or include any data and/or information regarding the manufacturer associated with the respective manufacturer computer 60, and/or data and/or information regarding the name, address, telephone number, email address, text, SMS, or instant messaging, number, website address, url, and/or any other identifying and/or contact information for the manufacturer.

The database 60H can contain and/or include data and/or information regarding all goods, products, and/or articles of commerce, which are manufactured by the manufacturer associated with the manufacturer computer 60. The database 60H can contain and/or include, for each good, product, or article of commerce, manufactured by the manufacturer associated with the manufacturer computer 60, data and/or information regarding a name or brand name of same, the product line of same, a generic description of same, a detailed description of same, the model number of same, available models of same, a serial number of or for same, available sizes for same, available colors for same, a price or prices for same, information identifying one or more retail sellers of same, information regarding sales, discounts, sales coupons, discount coupons, or manufacturer rebates for same, and/or any other information regarding use instructions, care instructions, and/or washing or cleaning instructions, for same (if applicable). The database 60H can contain and/or include, for each good, product, or article of commerce, manufactured by the manufacturer associated with the manufacturer computer 60, data and/or information regarding warranty information, inventory information, available inventory, and/or any other data and/or information regarding the respective good, product, or article, which may be of interest to any users, individuals, venues, manufacturers, retailers, advertisers, marketing entities, social networks, or financial institutions, who of which utilize the apparatus 100 of the present invention.

The database 60H can contain and/or include, for each good, product, or article of commerce, manufactured by the manufacturer associated with the manufacturer computer 60, data and/or information regarding the RFID tag 30 which is attached to, affixed to, or placed on or in the respective good, product, or article of commerce.

The database 60H can also contain and/or include, for each good, product, or article of commerce, manufactured by the manufacturer associated with the manufacturer computer 60, data and/or information regarding manufacturing date(s), production date(s), manufacturing time(s), production time(s), manufacturing location, production location, manufacturing or production batch number, lot number, and/or any other information, for or regarding any of the good, product, or article. In a preferred embodiment, any data and/or information regarding manufacturing date(s), production date(s), manufacturing time(s), production time(s), manufacturing location, production location, manufacturing or production batch number, lot number, and/or any other information, for or regarding any good, product, or article, can be utilized to document goods, products, or articles, purchased by any user or individual and can also be utilized to provide an alert message(s) or a notification message(s) when a good, product, or article, might be available for sale, might be on back-order, and/or be might the subject of a recall of any type or kind.

The database 60H can also contain data and/or information regarding any accounts the user or individual has or holds with the manufacturer. The database 60H can also contain and/or include any other data and/or information which is needed or desired for enabling the manufacturer computer 60 to perform all of the operations and functions described herein as being capable of being performed by the manufacturer computer 60 and/or the apparatus 100.

The database 60H can also contain and/or include any data and/or information described herein as being contained and/or included in any of the herein-described and respective databases for each of the central processing computer(s) 10, the user communication devices 20, the RFID reader systems 40, the venue computers 50, the retailer computers 70, the advertiser/marketing entity computers 80, the social network computers 90, and/or the financial institution computers 95, described herein. The database 60H can also be connected to the CPU 60A.

The manufacturer computer 60 also includes an output device(s) 60I for outputting any of the data and/or information described herein as being generated by or via the manufacturer computer 60. In the preferred embodiment, the output device(s) 60I can be a printer, a display, a transmitter, a modem, and/or any other device which can be used to output data or information of any kind or type. The output device(s) 60I can also be connected to the CPU 60A.

The manufacturer computer 60 can also include a video and/or audio recording device(s) 60J which can include a camera and/or a video recording device for recording pictures or video and/or video clips and/or a microphone or an audio recording device for recording audio or audio clips which can be recorded by, and/or transmitted live, by or from the manufacturer computer 60, or which can be recorded by, and stored at or in, the manufacturer computer 60 for transmission by or from the manufacturer computer 60 at a later time. The video and/or audio recording device(s) 60J can also be utilized to facilitate one-way broadcasts from the manufacturer computer 60, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the manufacturer computer 60 can engage in telephone calls and video conferencing calls via the same. The user or operator of the manufacturer computer 60 can also use the video and/or audio recording device(s) 60J to record and broadcast or transmit content via its transmitter 60F. The video and/or audio recording device(s) 60J can also be connected to the CPU 60A.

With reference to FIG. 6, the manufacturer computer 60, in the preferred embodiment, also includes a global positioning device 60K for determining the position or location of the manufacturer computer 60. The global positioning device 60K can also be connected to the CPU 60A.

With reference to FIG. 6, the manufacturer computer 60, in the preferred embodiment, can also include on or more RFID readers 60L which can be any commercially available RFID reader device(s) which can be suitable for use with the kind or type of manufacturer computer 60 which is utilized and the particular RFID reading functionality required by the manufacturer computer 60.

FIG. 7 illustrates the retailer computer 70 of FIG. 1, in block diagram form. With reference to FIG. 7, in the preferred embodiment, the retailer computer 70 includes a central processing unit or CPU 70A which, in the preferred embodiment, is a microprocessor. The CPU 70A may also be a microcomputer, a minicomputer, a macro-computer, and/or a mainframe computer, depending upon the application. The CPU 70A is specially programmed and/or specially configured to perform any and/or all of the functionality described herein as being performed by the retailer computer 70.

The retailer computer 70 also includes a random access memory (RAM) device(s) 70B and a read only (ROM) memory device(s) 70C, each of which is connected to the CPU 70A, and a user input device(s) 70D, for entering data or information and/or instructions and/or commands into the retailer computer 70. The user input device(s) 70D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the retailer computer 70. The user input device(s) 70D is/are also connected to the CPU 70A.

The retailer computer 70 also includes a display device 70E for displaying data and/or information to a user. The retailer computer 70 also includes a transmitter 70F, for transmitting signals and/or data and/or information to any one or more of the central processing computers 10, the user communication devices 20, the RFID reader systems 40, the venue computers 50, the manufacturer computers 60, the advertiser/marketing entity computers 80, the social network computers 90, and/or the financial institution computers 95, or to any of the other retailer computers 70.

The retailer computer 70 also includes a receiver 70G, for receiving signals and/or data and/or information from any one or more of the central processing computers 10, the user communication devices 20, the RFID reader systems 40, the venue computers 40, the manufacturer computers 60, the advertiser/marketing entity computers 80, the social network computers 90, and/or the financial institution computers 95, or from any of the other retailer computers 70.

The retailer computer 70 also includes a database(s) 70H. The database 70H can contain and/or be linked to any of the data and/or information described herein as being stored in the database 10H. The database 70H can also contain and/or include any data and/or information regarding the retailer or retail seller associated with the respective retailer computer 70, and/or data and/or information regarding the name, address, telephone number, email address, text, SMS, or instant messaging, number, website address, url, and/or any other identifying and/or contact information for the retailer or the retail seller.

The database 70H can contain and/or include data and/or information regarding all goods, products, and/or articles of commerce, which are offered for sale or sold by the retailer or the retail seller associated with the retailer computer 70. The database 70H can contain and/or include, for each good, product, or article of commerce, offered for sale or sold by the retailer or the retail seller associated with the retailer computer 70, data and/or information regarding a name or brand name of same, the manufacturer of same, the product line of same, a generic description of same, a detailed description of same, the model number of same, available models of same, a serial number of or for same, available sizes for same, available colors for same, a price or prices for same, information identifying one or more locations of the retailer or retail seller, information regarding sales, discounts, sales coupons, discount coupons, or manufacturer and/or retailer rebates for same, and/or any other information regarding use instructions, care instructions, and/or washing or cleaning instructions, for same (if applicable). The database 70H can contain and/or include, for each good, product, or article of commerce, offered for sale or sold by the retailer or the retail seller associated with the retailer computer 70, data and/or information regarding warranty information, inventory information, available inventory, and/or any other data and/or information regarding the respective good, product, or article, which may be of interest to any users, individuals, venues, manufacturers, retailers, advertisers, marketing entities, social networks, or financial institutions, who of which utilize the apparatus 100 of the present invention.

The database 70H can contain and/or include, for each good, product, or article of commerce, offered for sale or sold by the retailer or the retail seller associated with the retailer computer 70, data and/or information regarding the RFID tag 30 which is attached to, affixed to, or placed on or in the respective good, product, or article of commerce.

The database 70H can also contain and/or include, for each good, product, or article of commerce, offered for sale or sold by the retailer or the retail seller associated with the retailer computer 70, data and/or information regarding manufacturing date(s), production date(s), manufacturing time(s), production time(s), manufacturing location, production location, manufacturing or production batch number, lot number, and/or any other information, for or regarding any of the good, product, or article. In a preferred embodiment, any data and/or information regarding manufacturing date(s), production date(s), manufacturing time(s), production time(s), manufacturing location, production location, manufacturing or production batch number, lot number, and/or any other information, for or regarding any good, product, or article, can be utilized to document goods, products, or articles, purchased by any user or individual and can also be utilized to provide an alert message(s) or a notification message(s) when a good, product, or article, might be available for sale, might be on back-order, and/or be might the subject of a recall of any type or kind.

The database 70H can also contain data and/or information regarding any accounts the user or individual has or holds with the retailer or retail seller. The database 70H can also contain and/or include any other data and/or information which is needed or desired for enabling the retailer computer 70 to perform all of the operations and functions described herein as being capable of being performed by the retailer computer 70 and/or the apparatus 100.

The database 70H can also contain and/or include any data and/or information described herein as being contained and/or included in any of the herein-described and respective databases for each of the central processing computer(s) 10, the user communication devices 20, the RFID reader systems 40, the venue computers 50, the manufacturer computers 60, the advertiser/marketing entity computers 80, the social network computers 90, and/or the financial institution computers 95, described herein. The database 70H can also be connected to the CPU 70A.

The retailer computer 70 also includes an output device(s) 70I for outputting any of the data and/or information described herein as being generated by or via the retailer computer 70. In the preferred embodiment, the output device(s) 70I can be a printer, a display, a transmitter, a modem, and/or any other device which can be used to output data or information of any kind or type. The output device(s) 70I can also be connected to the CPU 70A.

The retailer computer 70 can also include a video and/or audio recording device(s) 70J which can include a camera and/or a video recording device for recording pictures or video and/or video clips and/or a microphone or an audio recording device for recording audio or audio clips which can be recorded by, and/or transmitted live, by or from the retailer computer 70, or which can be recorded by, and stored at or in, the retailer computer 70 for transmission by or from the retailer computer 70 at a later time. The video and/or audio recording device(s) 70J can also be utilized to facilitate one-way broadcasts from the retailer computer 70, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the retailer computer 70 can engage in telephone calls and video conferencing calls via the same. The user or operator of the retailer computer 70 can also use the video and/or audio recording device(s) 70J to record and broadcast or transmit content via its transmitter 70F. The video and/or audio recording device(s) 70J can also be connected to the CPU 70A.

With reference to FIG. 7, the retailer computer 70, in the preferred embodiment, also includes a global positioning device 70K for determining the position or location of the retailer computer 70. The global positioning device 70K can also be connected to the CPU 70A.

With reference to FIG. 7, the retailer computer 70, in the preferred embodiment, can also include on or more RFID readers 70L which can be any commercially available RFID reader device(s) which can be suitable for use with the kind or type of retailer computer 70 which is utilized and the particular RFID reading functionality required by the retailer computer 70. In a preferred embodiment, the RFID readers 70L can be utilized, as described herein, in order to register an RFID tag 30 with a user or an individuals upon the user's or individual's purchase of any good, product, or article of commerce, to, on, or in, which the RFID tag 30 is attached, affixed, or included. In a preferred embodiment, the RFID readers 70 can also be utilized in any other manner deemed necessary, appropriate, or useful for the respective retailer.

FIG. 8 illustrates the advertiser/marketing entity computer 80 of FIG. 1, in block diagram form. With reference to FIG. 8, in the preferred embodiment, the advertiser/marketing entity computer 80 includes a central processing unit or CPU 80A which, in the preferred embodiment, is a microprocessor. The CPU 80A may also be a microcomputer, a minicomputer, a macro-computer, and/or a mainframe computer, depending upon the application. The CPU 80A is specially programmed and/or specially configured to perform any and/or all of the functionality described herein as being performed by the advertiser/marketing entity computer 80.

The advertiser/marketing entity computer 80 also includes a random access memory (RAM) device(s) 80B and a read only (ROM) memory device(s) 80C, each of which is connected to the CPU 80A, and a user input device(s) 80D, for entering data or information and/or instructions and/or commands into the advertiser/marketing entity computer 80. The user input device(s) 80D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the advertiser/marketing entity computer 80. The user input device(s) 80D is/are also connected to the CPU 80A.

The advertiser/marketing entity computer 80 also includes a display device 80E for displaying data and/or information to a user. The advertiser/marketing entity computer 80 also includes a transmitter 80F, for transmitting signals and/or data and/or information to any one or more of the central processing computers 10, the user communication devices 20, the RFID reader systems 40, the venue computers 50, the manufacturer computers 60, the retailer computers 70, the social network computers 90, and/or the financial institution computers 95, or to any of the other advertiser/marketing entity computers 80.

The advertiser/marketing entity computer 80 also includes a receiver 80G, for receiving signals and/or data and/or information from any one or more of the central processing computers 10, the user communication devices 20, the RFID reader systems 40, the venue computers 40, the manufacturer computers 60, the retailer computers 70, the social network computers 90, and/or the financial institution computers 95, or from any of the other advertiser/marketing entity computers 80.

The advertiser/marketing entity computer 80 also includes a database(s) 80H. The database 80H can contain and/or be linked to any of the data and/or information described herein as being stored in the database 10H. The database 80H can also contain and/or include any data and/or information regarding the advertiser or marketing entity associated with the respective advertiser/marketing entity computer 80, and/or data and/or information regarding the name, address, telephone number, email address, text, SMS, or instant messaging, number, website address, url, and/or any other identifying and/or contact information for the advertiser or marketing entity.

The database 80H can contain and/or include data and/or information regarding each of and/or all of the goods, products, and/or articles of commerce, which are offered for sale or sold by any of the herein-described manufacturers, retailers, or retail sellers, which utilize the apparatus 100 of the present invention, along with data and/or information regarding each manufacturer, retailer, or retail seller.

The database 80H can also contain and/or include, for each good, product, or article of commerce, offered for sale or sold by each manufacturer, retailer, or retail seller, advertisements and/or advertising information for the same, with such advertisements and/or advertising information including video clips, audio clips, text advertisements, commercials, infomercials, and/or any other advertising content, for or regarding the respective good, product, or article.

The database 80H can also contain and/or include, for each good, product, or article of commerce, offered for sale or sold by each manufacturer, retailer, or retail seller, marketing information for the same, with such marketing information including video clips, audio clips, text advertisements, commercials, infomercials, and/or any other marketing content, good, product, or article reviews, and/or any other marketing materials, for or regarding the respective good, product, or article.

The database 80H can also contain and/or include, for each manufacturer, retailer, or retail seller, of or for each good, product, or article of commerce, any data and/or information regarding the respective manufacturer, retailer, or retail seller, including, but not limited to, name, address, telephone number, email address, text, SMS, or instant messaging, number, website address, url, and/or any other identifying and/or contact information for the respective manufacturer, retailer, or retail seller.

Any of the herein-described data and/or information stored in the database 80H can be provided to, or accessed by, any user or individual, or any other entity described herein, who or which can utilize the apparatus 100 of the present invention.

The database 80H can also contain data and/or information regarding any accounts the user or individual has or holds with the advertiser or marketing entity. The database 80H can also contain and/or include any other data and/or information which is needed or desired for enabling the advertiser/marketing entity computer 80 to perform all of the operations and functions described herein as being capable of being performed by the advertiser/marketing entity computer 80 and/or the apparatus 100.

The database 80H can also contain and/or include any data and/or information described herein as being contained and/or included in any of the herein-described and respective databases for each of the central processing computer(s) 10, the user communication devices 20, the RFID reader systems 40, the venue computers 50, the manufacturer computers 60, the retailer computers 70, the social network computers 90, and/or the financial institution computers 95, described herein. The database 80H can also be connected to the CPU 80A.

The advertiser/marketing entity computer 80 also includes an output device(s) 80I for outputting any of the data and/or information described herein as being generated by or via the advertiser/marketing entity computer 80. In the preferred embodiment, the output device 80I can be a printer, a display, a transmitter, a modem, and/or any other device which can be used to output data or information of any kind or type. The output device(s) 80I can also be connected to the CPU 80A.

The advertiser/marketing entity computer 80 can also include a video and/or audio recording device(s) 80J which can include a camera and/or a video recording device for recording pictures or video and/or video clips and/or a microphone or an audio recording device for recording audio or audio clips which can be recorded by, and/or transmitted live, by or from the advertiser/marketing entity computer 80, or which can be recorded by, and stored at or in, the advertiser/marketing entity computer 80 for transmission by or from the advertiser/marketing entity computer 80 at a later time. The video and/or audio recording device(s) 80J can also be utilized to facilitate one-way broadcasts from the advertiser/marketing entity computer 80, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the advertiser/marketing entity computer 80 can engage in telephone calls and video conferencing calls via the same. The user or operator of the advertiser/marketing entity computer 80 can also use the video and/or audio recording device(s) 80J to record and broadcast or transmit content via its transmitter 80F. The video and/or audio recording device(s) 80J can also be connected to the CPU 80A.

With reference to FIG. 8, the advertiser/marketing entity computer 80, in the preferred embodiment, also includes a global positioning device 80K for determining the position or location of the advertiser/marketing entity computer 80. The global positioning device 80K can also be connected to the CPU 80A.

FIG. 9 illustrates the social network computer 90 of FIG. 1, in block diagram form. With reference to FIG. 9, in the preferred embodiment, the social network computer 90 includes a central processing unit or CPU 90A which, in the preferred embodiment, is a microprocessor. The CPU 90A may also be a microcomputer, a minicomputer, a macro-computer, and/or a mainframe computer, depending upon the application. The CPU 90A is specially programmed and/or specially configured to perform any and/or all of the functionality described herein as being performed by the social network computer 90.

The social network computer 90 also includes a random access memory (RAM) device(s) 90B and a read only (ROM) memory device(s) 90C, each of which is connected to the CPU 90A, and a user input device(s) 90D, for entering data or information and/or instructions and/or commands into the social network computer 90. The user input device(s) 90D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the social network computer 90. The user input device(s) 90D is/are also connected to the CPU 90A.

The social network computer 90 also includes a display device 90E for displaying data and/or information to a user. The social network computer 90 also includes a transmitter 90F, for transmitting signals and/or data and/or information to any one or more of the central processing computers 10, the user communication devices 20, the RFID reader systems 40, the venue computers 50, the manufacturer computers 60, the retailer computers 70, the advertiser/marketing entity computers 80, and/or the financial institution computers 95, or to any of the other social network computers 90.

The social network computer 90 also includes a receiver 90G, for receiving signals and/or data and/or information from any one or more of the central processing computers 10, the user communication devices 20, the RFID reader systems 40, the venue computers 40, the manufacturer computers 60, the retailer computers 70, advertiser/marketing entity computers 80, and/or the financial institution computers 95, or from any of the other social network computers 90.

The social network computer 90 also includes a database(s) 90H. The database 90H can contain and/or be linked to any of the data and/or information described herein as being stored in the database 10H. The database 90H can also contain and/or include any data and/or information regarding the social network associated with the respective social network computers 90, and/or data and/or information regarding the name, address, telephone number, email address, text, SMS, or instant messaging, number, website address, url, and/or any other identifying and/or contact information for the social network associated with the social network computer 90.

The database 90H can also contain and/or include, for each user, individual, RFID reader operator or RFID system operator, venue, manufacturer, retailer, retail seller, advertiser, marketing entity, other social network operator, and/or financial institution, who or which utilizes the apparatus 100 of the present invention and is a member of the social network, any data and/or information regarding the name, address, telephone number, email address, text, SMS, or instant messaging, number, website address, url, and/or any other identifying and/or contact information for the respective user, individual, RFID reader operator or RFID system 40 operator, venue, manufacturer, retailer, retail seller, advertiser, marketing entity, other social network operator, or financial institution.

The database 90H can also contain and/or include, for each user, individual, RFID reader operator or RFID system 40 operator, venue, manufacturer, retailer, retail seller, advertiser, marketing entity, other social network operator, and/or financial institution, who or which utilizes the apparatus 100 of the present invention and is a member of the social network, any data and/or information regarding the respective user's, individual's, RFID reader operator's or RFID system 40 operator's, venue's, manufacturer's, retailer's, retail seller's, advertiser's, marketing entity's, other social network operator's, or financial institution's, social networking page, profile, friends, followers, messages, comments, and/or postings made by and/or on the respective social networking page.

The database 90H can contain and/or include data and/or information regarding each of, and/or all of, the goods, products, and/or articles of commerce, which are offered for sale or sold by any of the herein-described manufacturers, retailers, or retail sellers, which utilize the apparatus 100 of the present invention, along with data and/or information regarding each manufacturer, retailer, or retail seller.

The database 90H can also contain and/or include, for each good, product, or article of commerce, offered for sale or sold by each manufacturer, retailer, or retail seller, data and/or information regarding a social networking page, profile, friends, followers, messages, comments, for, and/or any postings for or regarding, the respective good, product, or article of commerce.

The database 90H can also contain and/or include, for each good, product, or article of commerce, offered for sale or sold by each manufacturer, retailer, or retail seller, any of the herein-described advertising information and/or marketing information for the same.

The database 90H can also contain and/or include, for each good, product, or article of commerce, and/or for each manufacturer, retailer, or retail seller, of the same, data and/or information regarding a website address, url, and/or any other identifying and/or contact information for the respective manufacturer, retailer, or retail seller, or good, product, or article of commerce.

Any of the herein-described data and/or information stored in the database 90H can be provided to, or accessed by, any user or individual, or any other entity described herein, who or which can utilize the apparatus 100 of the present invention.

The database 90H can also contain and/or include any other data and/or information which is needed or desired for enabling the social network computer 90 to perform all of the operations and functions described herein as being capable of being performed by the social network computer 90 and/or the apparatus 100.

The database 90H can also contain and/or include any data and/or information described herein as being contained and/or included in any of the herein-described and respective databases for each of the central processing computer(s) 10, the user communication devices 20, the RFID reader systems 40, the venue computers 50, the manufacturer computers 60, the retailer computers 70, the advertiser/marketing entity computers 80, and/or the financial institution computers 95, described herein. The database 90H can also be connected to the CPU 90A.

The social network computer 90 also includes an output device(s) 90I for outputting any of the data and/or information described herein as being generated by or via the social network computer 90. In the preferred embodiment, the output device(s) 90I can be a printer, a display, a transmitter, a modem, and/or any other device which can be used to output data or information of any kind or type. The output device(s) 90I can also be connected to the CPU 90A.

The social network computer 90 can also include a video and/or audio recording device(s) 90J which can include a camera and/or a video recording device for recording pictures or video and/or video clips and/or a microphone or an audio recording device for recording audio or audio clips which can be recorded by, and/or transmitted live, by or from the social network computer 90, or which can be recorded by, and stored at or in, the social network computer 90 for transmission by or from the social network computer 90 at a later time. The video and/or audio recording device(s) 90J can also be utilized to facilitate one-way broadcasts from the social network computer 90, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the social network computer 90 can engage in telephone calls and video conferencing calls via the same. The user or operator of the social network computer 90 can also use the video and/or audio recording device(s) 90J to record and broadcast or transmit content via its transmitter 90F. The video and/or audio recording device(s) 90J can also be connected to the CPU 90A.

With reference to FIG. 9, the social network computer 90, in the preferred embodiment, also includes a global positioning device 90K for determining the position or location of the social network computer 90. The global positioning device 90K can also be connected to the CPU 90A.

FIG. 10 illustrates the financial institution computer 95 of FIG. 1, in block diagram form. With reference to FIG. 10, in the preferred embodiment, the financial institution computer 95 includes a central processing unit or CPU 95A which, in the preferred embodiment, is a microprocessor. The CPU 95A may also be a microcomputer, a minicomputer, a macro-computer, and/or a mainframe computer, depending upon the application. The CPU 95A is specially programmed and/or specially configured to perform any and/or all of the functionality described herein as being performed by the financial institution computer 95.

The financial institution computer 95 also includes a random access memory (RAM) device(s) 95B and a read only (ROM) memory device(s) 95C, each of which is connected to the CPU 95A, and a user input device(s) 95D, for entering data or information and/or instructions and/or commands into the financial institution computer 95. The user input device(s) 95D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the financial institution computer 95. The user input device(s) 95D is/are also connected to the CPU 95A.

The financial institution computer 95 also includes a display device 95E for displaying data and/or information to a user. The financial institution computer 95 also includes a transmitter 95F, for transmitting signals and/or data and/or information to any one or more of the central processing computers 10, the user communication devices 20, the RFID reader systems 40, the venue computers 50, the manufacturer computers 60, the retailer computers 70, the advertiser/marketing entity computers 80, and/or the social network computers 90, or to any of the other financial institution computers 95.

The financial institution computer 95 also includes a receiver 95G, for receiving signals and/or data and/or information from any one or more of the central processing computers 10, the user communication devices 20, the RFID reader systems 40, the venue computers 40, the manufacturer computers 60, the retailer computers 70, advertiser/marketing entity computers 80, and/or the social network computers 90, or from any of the other financial institution computers 95.

The financial institution computer 95 also includes a database(s) 95H. The database 95H can contain and/or be linked to any of the data and/or information described herein as being stored in the database 10H. The database 95H can also contain and/or include any data and/or information regarding the name, address, telephone number, email address, text, SMS, or instant messaging, number, website address, url, account information, and/or any other identifying and/or contact information for the financial institution associated with the financial institution computer 95.

The database 95H can also contain and/or include, for each user, individual, RFID reader operator or RFID system operator, venue, manufacturer, retailer, retail seller, advertiser, marketing entity, social network operator, and/or other financial institution, who or which utilizes the apparatus 100 of the present invention and has a financial account with the financial institution associated with the financial institution computer 95, data and/or information regarding the name, address, financial account information, financial account number(s) or identifier(s), telephone number, email address, text, SMS, or instant messaging, number, and/or any other needed or desired data and/or information, for or regarding the respective user, individual, RFID reader operator or RFID system operator, venue, manufacturer, retailer, retail seller, advertiser, marketing entity, social network operator, and/or other financial institution, and/or any financial account(s) held by the respective user, individual, RFID reader operator or RFID system operator, venue, manufacturer, retailer, retail seller, advertiser, marketing entity, social network operator, and/or other financial institution.

The database 95H can also contain and/or include any other data and/or information which is needed or desired for enabling the financial institution computer 95 to perform all of the operations and functions described herein as being capable of being performed by the financial institution computer 95 and/or the apparatus 100.

The database 95H can also contain and/or include any data and/or information described herein as being contained and/or included in any of the herein-described and respective databases for each of the central processing computer(s) 10, the user communication devices 20, the RFID reader systems 40, the venue computers 50, the manufacturer computers 60, the retailer computers 70, the advertiser/marketing entity computers 80, the social network computers 90, and/or the financial institution computers 95, described herein. The database 95H can also be connected to the CPU 95A.

The financial institution computers 95, also includes an output device(s) 95I for outputting any of the data and/or information described herein as being generated by or via the financial institution computers 95. In the preferred embodiment, the output device 95I can be a printer, a display, a transmitter, a modem, and/or any other device which can be used to output data or information of any kind or type. The output device(s) 95I can also be connected to the CPU 95A.

The financial institution computers 95 can also include a video and/or audio recording device(s) 95J which can include a camera and/or a video recording device for recording pictures or video and/or video clips and/or a microphone or an audio recording device for recording audio or audio clips which can be recorded by, and/or transmitted live, by or from the financial institution computers 95, or which can be recorded by, and stored at or in, the financial institution computers 95, for transmission by or from the financial institution computers 95, at a later time. The video and/or audio recording device(s) 95J can also be utilized to facilitate one-way broadcasts from the financial institution computers 95, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the financial institution computers 95, can engage in telephone calls and video conferencing calls via the same. The user or operator of the financial institution computers 95 can also use the video and/or audio recording device(s) 95J to record and broadcast or transmit content via its transmitter 95F. The video and/or audio recording device(s) 95J can also be connected to the CPU 95A.

With reference to FIG. 10, the financial institution computers 95, in the preferred embodiment, also includes a global positioning device 95K for determining the position or location of the financial institution computers 95. The global positioning device 95K can also be connected to the CPU 95A.

The apparatus 100 and methods of the present invention can be utilized in a number of embodiments in order to allow users and individuals to identify and/or to be made aware of, and/or to obtain, or to be provided with, information regarding, any good, product, or article of commerce, which is equipped with an RFID tag 30, and/or to allow manufacturers, retailers, retail sellers, advertisers, and/or marketing entities, to promote, advertise, and/or sell or market, their respective goods, products, or articles of commerce, via the apparatus 100 of the present invention.

In a preferred embodiment, it is envisioned that all users, individuals, venues, manufacturers, retailers, retail sellers, advertisers, social networking entities, and/or financial institutions, can create, establish, and/or register, an account with the central processing computer 10 and/or apparatus 100, so as to become users or members of same.

The apparatus 100 and methods of the present invention can be utilized in connection with any goods, products, or articles of commerce, including, but not limited to apparel and/or clothing, fashion apparel and/or clothing, designer apparel and/or clothing, accessories of any and/or types or kinds, footwear, handbags, hats and/or other headwear, jackets and/or coats, bathing suits, jewelry of any and/or all types or kinds, watches of any and/or all types of kinds, computers, tablets, cellular telephones, smart phones, personal digital assistants, e-readers, and other consumer electronics products, of any and/or all types or kinds, consumer products of any and/or all types or kinds, exercise equipment, bicycles, and/or vehicles, of any and/or all types or kinds, consumer and/or personal products of any and/or types or kinds, and/or any other good(s), product(s), and/or article(s) of commerce, of any and/or all types or kinds. Put simply, in a preferred embodiment, the apparatus 100 and methods of the present invention can be utilized with any type or kind of good(s), product(s), or article(s) of commerce, to which or in which any suitable or appropriate RFID tag 30 can be attached, affixed, or placed.

The apparatus 100 and methods of the present invention can also be utilized in connection with, and/or in conjunction with, any number of types or kinds of suitable and/or appropriate RFID tags 30 which are available in the marketplace as of the filing date of the present application, as well those suitable and/or appropriate RFID tags 30 which can be provided or made available in the future. The RFID tags 30, in a preferred embodiment, can be passive RFID tags 30. It is also important to note that active RFID tags 30 can also be utilized in connection with, and/or in conjunction with, the apparatus 100 of the present invention.

The apparatus 100 and methods of the present invention can also be utilized in connection with, and/or in conjunction with, any number of types or kinds of suitable and/or appropriate RFID readers which are available in the marketplace as of the filing date of the present application, as well those suitable and/or appropriate RFID readers which can be provided or made available in the future. The RFID readers, in a preferred embodiment, can be RFID readers for passive RFID tags 30. It is also important to note that the RFID readers can also be RFID readers for active RFID tags 30.

In a preferred embodiment, any data and/or information regarding any good, product, or article of commerce, with which the apparatus 100 of the present invention can be used, can be stored in the database 10H of the central processing computer 10. Data and/or information regarding each respective good, product, or article of commerce, can, for example, include, but not be limited to, the name or a generic description, a brand name, the manufacturer or manufacturers, one or more retailers or retail sellers, the price, available sizes, available colors, reviews, warranty information, use instructions, care instructions, cleaning instructions, washing instructions, available sales or discounts, available discount coupons, a link or links to a retailer(s) or retail seller(s) from which the good, product, or article of commerce, can be purchased, a link or links to a manufacturer website, a retailer or retail seller website, and/or a social network webpage, and/or any other information, of, for, or regarding, the respective good, product, or article of commerce (hereinafter also referred to as the “good, product, or article, information”).

In a preferred embodiment, any data and/or information regarding any RFID tag 30 with which the apparatus 100 of the present invention can be used, can also be stored in the database 10H of the central processing computer 10. Data and/or information regarding each RFID tag 30 can, for example, include, but not be limited to, the name, manufacturer, type of RFID tag, such as, for example, a passive RFID tag or an active RFID tag, and/or any other information regarding, each respective RFID tag 30.

In a preferred embodiment, any data and/or information regarding any RFID reader with which the apparatus 100 of the present invention can be used, can also be stored in the database 10H of the central processing computer 10. Data and/or information regarding each RFID reader can, for example, include, but not be limited to, the name, manufacturer, type of RFID reader (such as, for example, passive RFID reader or active RFID reader), and/or any other information regarding, each respective RFID reader.

In a preferred embodiment, each RDIF tag 30, utilized with the present invention, can be assigned a unique serial number of other unique identification number or identifier number or code. In a preferred embodiment, each RFID tag 30 can be assigned to each good, product, or article of commerce, sold by a manufacturer, a retailer, a retail seller, or a distributor, upon the sale of the same, or by a respective manufacturer, retailer, retail seller, on-line seller, distributor, or shipper, upon a shipment of the same. In this regard, in a preferred embodiment, a unique RFID tag 30 can be assigned to each respective good, product, or article of commerce, to which it is attached or affixed, or on or in which it is placed, by an appropriate entity at the appropriate time before delivery or shipment of the respective good, product, or article of commerce, to a purchasing consumer, user, or individual. Any data and/or information regarding each RFID tag 30 utilized with the apparatus 100, along with data and/or information regarding the respective good, product, or article of commerce, to which the RFID tag 30 is assigned, can be stored and maintained in the database 10H of the central processing computer 10.

In another preferred embodiment, an RFID tag 30 can be attached to, affixed to, or placed on or in, a good, product, or article of commerce, by its respective manufacturer, distributor, or retailer or retail seller, or shipper, at any appropriate time, and the RFID tag 30 can then be registered with, and/or associated with, the respective good, product, or article of commerce. Upon being registered or becoming associated with the RFID tag 30, information regarding the good, product, or article of commerce, can be accessible via the information read from the RFID tag 30.

In a preferred embodiment, each user or individual who uses the apparatus 100 can create a user account with the apparatus 100 and/or with the central processing computer 10. The user account can store any of the herein-described data and/or information regarding the user or individual. The user account for each user or individual can also store information regarding each RFID tag 30 which is registered with the user or individual, as described herein, along with data and/or information regarding the respective good, product, or article of commerce, to which each RFID tag 30 is assigned. As noted herein, in a preferred embodiment, each RFID tag 30 can be attached to, affixed to, or place on or in, the respective good, product, or article of commerce, to which the RFID tag 30 is assigned.

The apparatus 100 and methods of the present invention can be utilized in any number of various preferred embodiments in order to allow the herein-described users, individuals, venues, manufacturers, retailers, retail sellers, advertisers, social networking entities, and/or financial institutions, to benefit from the same in a variety of ways.

In a preferred embodiment, a user or individual can create, establish, and/or register, a user account with the central processing computer 10 and/or the apparatus 100. In a preferred embodiment, the user account can contain data and/or information regarding any number of RFID tags 30 which are registered to the user as well as any data and/or information regarding each good, product, or article of commerce, to which each RFID tag 30 is assigned.

FIG. 11 illustrates a preferred embodiment method for utilizing the apparatus and methods of the present invention, in flow diagram form. With reference to FIG. 11, the operation of the apparatus 100 commences at step 1100. At step 1101, the user or individual can access the central processing computer 10 via his or her user communication device 20. At step 1102, the central processing computer 10 can transmit, to the user communication device 20, a registration form for creating a user account with the apparatus 100 and/or the central processing computer 10.

At step 1102, the user or individual can provide any necessary and/or desired information for creating a user account. At step 1102, the user or individual can also request, or agree, to receive promotional materials, marketing materials, and/or discount coupons, from any venues, manufacturers, retailers, retail sellers, advertisers, and/or marketing entities, an/or any of the social networks and/or financial institutions, which utilize the apparatus 100 of the present invention. At step 1102, the user or individual can also join a social network which also utilizes the apparatus 100 of the present invention. At step 1102, the user or individual can also create or establish a financial account with a financial institution, which financial account can be linked to his or her user account.

In a preferred embodiment, the user or individual, at step 1102, can also register a personal RFID reader or a personal RFID reader system 40 with the central processing computer 10. The personal RFID reader or a personal RFID reader system 40, in a preferred embodiment, can be integrated with, attached to, wirelessly linked to or with, or in wireless communication with, any suitable user communication device 20, such as, for example, but not limited to a cellular telephone, a smart phone, a personal digital assistant, tablet, table computer, e-reader, or a watch or smart watch. In instances where the user communication device 20 and the personal RFID reader or a personal RFID reader system 40 are not physically or electrically connected or linked with one another, they can be linked via any suitable wireless communication device, technology, network, or system. In a preferred embodiment, the user communication device 20 and the personal RFID reader or a personal RFID reader system 40 can be linked with one another using Bluetooth equipment and/or technologies, and/or any other wireless equipment and/or technologies.

At step 1103, the user or individual can transmit, from his or her user communication device 20, any and/or all data and/or information which he or she entered into his or her user communication device 20 at step 1102, to the central processing computer 10. At step 1104, the central processing computer 10 can receive and process the data and/or information which was transmitted from the user communication device 20. At step 1105, the central processing computer 10 can create or establish a user account for the user or individual. At step 1105, the central processing computer 10, in a preferred embodiment, can assign a user identification number, or other unique identifier, to the user or individual and/or to the newly created user account of the user or individual. At step 1106, the central processing 10 can store any and/or all data and/or information regarding the newly created user account in the database 10H. Thereafter, the operation of the apparatus will cease at step 1107.

In another preferred embodiment, the user or individual, at any time, can access and update data and/or information in his or her user account and/or can add new information to the same.

In another preferred embodiment, once an RFID tag 30 is assigned to a good, product, or article of commerce, such as by being attached to, affixed to, or placed on or in, the respective good, product, or article of commerce, by a respective manufacturer, distributor, or retailer or retail seller, or shipper, the RFID tag 30 can then be registered with the central processing computer 10. Once the respective RFID tag 30 is registered with the central processing computer 10, information regarding the respective good, product, or article of commerce, to which the RFID tag 30 is assigned, can then be obtained by, or provided to, any user or individual upon the reading of the RFID tag 30 with an appropriate RFID reader or an appropriate RFID reader system 40.

FIG. 12 illustrates another preferred embodiment method for utilizing the apparatus and methods of the present invention, in flow diagram form. With reference to FIG. 12, the operation of the apparatus 100 commences at step 1200. At step 1201, a respective manufacturer, retailer, retail seller, distributor, or shipper, of a good, product, or article of commerce, can, at the time of the respective manufacture, sale, or shipment, of the good, product, or article of commerce, can attach or affix an RFID tag 30 to the good, product, or article of commerce, or can place an RFID tag 30 on or in the good, product, or article of commerce, so as to assign the RFID tag 30 to the respective good, product, or article of commerce. At step 1202, the respective manufacturer, retailer, retail seller, distributor, or shipper, can use their respective manufacturer computer 60, retailer computer 70, or user communication device 20, in order to access the central processing computer 10.

At step 1203, the respective manufacturer, retailer, retail seller, distributor, or shipper, can use an RFID reader or an RFID reader system 40 in order to read and/or obtain information regarding the identification of the RFID tag 30, which is assigned to the respective good, product, or article of commerce, and can enter the same into its respective manufacturer computer 60, retailer computer 70, or user communication device 20. At step 1203, the manufacturer, retailer, retail seller, distributor, or shipper, can also enter information regarding the respective good, product, or article of commerce, to which the respective RFID tag 30 is assigned. At step 1204, the respective manufacturer, retailer, retail seller, distributor, or shipper, can transmit, from its respective manufacturer computer 60, retailer computer 70, or user communication device 20, the data and/or information regarding the RFID tag 30 and the respective good, product, or article of commerce, to which the respective RFID tag 30 is assigned, to the central processing computer 10.

At step 1205, the central processing computer 10 can receive and process the data and/or information regarding the RFID tag 30 and the data and/or information regarding respective good, product, or article of commerce, to which the respective RFID tag 30 is assigned, and can store the same in the database 10H. Thereafter, the operation of the apparatus 100 will cease at step 1206.

Thereafter, any data and/or information regarding the respective good, product, or article of commerce, and/or any of the herein-described good, product, or article, information for or regarding the respective good, product, or article of commerce, can be obtained from and via the central processing computer 10 by reading the respective RFID tag 30, assigned to that respective good, product, or article of commerce, and by transmitting identifying information regarding that respective RFID tag 30 to the central processing computer 10. In this regard, in a preferred embodiment, the central processing computer 10, upon receiving and processing RFID tag identification information read from an RFID tag 30, which can be transmitted from any RFID reader, RFID reader system 40, or any user communication device 20 (“the requesting device”), can process the received RFID tag identification information, identify the respective good, product, or article of commerce, to which the RFID tag 30 is assigned, and transmit any data and/or information regarding the respective good, product, or article of commerce, and/or any of the herein-described good, product, or article, information for or regarding the respective good, product, or article of commerce, to the requesting device.

In another preferred embodiment, the user or individual can elect to have the RFID tag 30 registered with his or her user account. In such an embodiment, the respective manufacturer, retailer, retail seller, distributor, or shipper, at step 1204, can transmit, from its respective manufacturer computer 60, retailer computer 70, or user communication device 20, information identifying the user's or individual's user account along with the data and/or information regarding the RFID tag 30 and the respective good, product, or article of commerce, to which the respective RFID tag 30 is assigned, to the central processing computer 10. Thereafter, the user or individual can have any one of more RFID tags 30 registered with his or her user account.

By having one of more RFID tags 30 registered with his or her user account, the user or individual can have, for each registered RFID tag 30, any of the herein-described data and/or information regarding the respective good, product, or article of commerce, and/or any of the herein-described good, product, or article, information for or regarding the respective good, product, or article of commerce, to which that RFID tag 30 is assigned. The user or individual can, in a preferred embodiment, access and retrieve the herein-described data and/or information regarding the respective good, product, or article of commerce, and/or any of the herein-described good, product, or article, information at any time and for any purpose.

In another preferred embodiment, the apparatus 100 and/or the central processing computer 10 can utilize RFID tags 30 which are registered with a user's or individual's account in order to effectuate an affiliated marketing program whereby the user or individual can earn, and can be paid, a commission payment, a referral fee, or other compensation, any time a reading of an RFID tag 30 registered to his or her account results in a purchase by another user or individual who utilizes the apparatus 100 of the present invention.

In another preferred embodiment, the user or individual, can utilize the personal RFID reader or the personal RFID reader system 40, along with his or her user communication device 20, to read an RFID tag 30 which is attached to, affixed to, or placed on or within, any good(s), product(s), or article(s) of commerce, of interest to the user or individual. Thereafter, the user or individual can retrieve, obtain, or otherwise be provided with any information regarding the respective good, product, or article of commerce, and/or the good, product, or article, information, of or for the respective good, product, or article of commerce, to which the respective RFID tag 30 is assigned. Thereafter, the user or individual can shop for the good, product, article of commerce, and/or engage in any other activities.

In another preferred embodiment, the user or individual, can utilize the personal RFID reader or the personal RFID reader system 40, along with his or her user communication device 20, to read any number of RFID tags 30 each of which can be attached to, affixed to, or placed on or within, any good(s), product(s), or article(s) of commerce, which is detected within a predetermined distance or radius of the user's or individual's user communication device 20. At any time, or at pre-defined time intervals, the user or individual, or his or her user communication device 20, can transmit a request to retrieve, obtain, or otherwise be provided with, a report, which can be searchable and which can contain or include, for each detected RFID tag 30 and its respective good, product, or article of commerce, any of the herein-described information regarding the good, product, or article of commerce, and/or the herein-described good, product, or article, information, of or for each respective good, product, or article of commerce.

Thereafter, the user or individual can review the report, search the report using any search words, terms, or phrases, and/or use any search filters, in order to retrieve, obtain, or otherwise be provided with information regarding each good, product, or article of commerce, or the herein-described good, product, or article, information, associated with each detected, and read, RFID tag 30, which is of interest to the user or individual. Thereafter, the user or individual can shop for the good, product, article of commerce, and/or engage in any other activities.

In a preferred embodiment, the user or individual who may have seen a good, product, or article of commerce, which may have caught his or her attention, in or at any location, can request, be provided with, and review, the report to see if the respective good, product, or article of commerce, was equipped with, or assigned, an RFID tag 30 in order to allow the user or individual to obtain information regarding the same, and/or, to engage in a subsequent shopping activity for the respective good, product, or article of commerce.

FIG. 13 illustrates still another preferred embodiment method for utilizing the apparatus 100 and methods of the present invention, in flow diagram form. With reference to FIG. 13, the operation of the apparatus 100 can commence at step 1300. At step 1301, the user or individual can use his or her user communication device 20 and associated RFID reader 20L and/or any RFID reader or RFID reader system 40 (“user communication device 20/RFID reader combination”), associated with user communication device 20 in order to read an RFID tag 30 or any number of RFID tags 30.

In a preferred embodiment, at step 1301, the user or individual can utilize the user communication device 20/RFID reader combination in order to manually activate the user communication device 20/RFID reader combination in a vicinity of a good, product, or article of commerce, in which the user or individual is interested. If the respective good, product, or article of commerce, is equipped with, or assigned, an RFID tag 30, the user communication device 20/RFID reader combination will read information from the RFID tag 30 and will provide an indication that such a reader was effected via the display device 20E or a display on the respective RFID reader 20L and/or any RFID reader or RFID reader system 40. After the indication is provided, the user communication device 20/RFID reader combination can process information regarding the RFID tag 30 detected and read and generate an information request regarding the same. This mode of operation is hereinafter referred to as the “single RFID tag read mode”.

In another preferred embodiment of FIG. 13, the user or individual, at step 1301, can activate an automatic RFID tag reader operating mode and select a predefined time interval during which the user communication device 20/RFID reader combination will read information from any number of the RFID tags 30 in the vicinity of the user communication device 20/RFID reader combination. The user communication device 20/RFID reader combination can also automatically read RFID tags 30 as the user or individual, and his or her user communication device 20/RFID reader combination move about in a close enough proximity to read an RFID tag 30 or RFID tags 30, and/or as goods, products, or articles of commerce, equipped with or assigned an RFID tag 30, moves about the user communication device 20/RFID reader combination in a close enough proximity to allow the user communication device 20/RFID reader combination to read a respective RFID tag 30 or any number of RFID tags 30. After each predefined time interval, the user communication device 20/RFID reader combination can process information regarding all of the RFID tags 30 detected and read and generate an information request regarding all of the RFID tags 30 detected and read. This mode of operation is hereinafter referred to as the “multiple RFID tag read mode”.

At step 1302, the user or individual can access the central processing computer 10 using the user communication device 20/RFID reader combination. At step 1303, the user or individual can use the user communication device 20/RFID reader combination to generate and to transmit an information request containing the information regarding the RFID tag 30 detected and read for the single RFID tag read mode, or to generate and to transmit an information request containing the information for the multiple RFID tag read mode, to the central processing computer 10. At step 1304, the central processing computer 10 can receive and process the information request, whether it be the information request from the single RFID tag read mode or from the multiple RFID tag read mode, which was transmitted from the user communication device 20/RFID reader combination at step 1303.

At step 1305, the central processing computer 10 can generate a report which can include or contain, for the single RFID tag read mode, information regarding the good, product, or article of commerce, and/or the good, product, or article, information, for the good, product, or article of commerce, equipped with, or assigned, the RFID tag 30, or the report can include or contain, for the multiple RFID tag read mode, for each RFID tag 30 detected and read, information regarding the good, product, or article of commerce, and/or the good, product, or article, information, for the respective good, product, or article of commerce, equipped with, or assigned, each respective RFID tag 30. At step 1305, the central processing computer 10 can transmit the report to the user communication 20/RFID reader combination and/or to any other user communication device 20 used by, or associated with the user or individual. In a preferred embodiment, the report can be transmitted directly to the user communication 20/RFID reader combination and/or to any other user communication device 20 used by, or associated with the user or individual. In another preferred embodiment, the report can also be transmitted to the user communication 20/RFID reader combination, and/or to any other user communication device 20 used by, or associated with, the user or individual, as, in, or as an attachment to, an email server associated with the user or individual, or as a text message or any other electronic transmission or communication.

At step 1306, the user or individual can obtain and review the report. In the case of a single RFID tag read mode, the user or individual can review the information contained in the report and can engage in any shopping activity regarding the good, product, or article of commerce, which was equipped with, or assigned, the RFID tag 30 which was detected and read. In a preferred embodiment, in addition to any information regarding the good, product, or article of commerce, and/or the good, product, or article, information, for the respective good, product, or article of commerce, the report can also contain or include information, a link(s), or hyperlink(s) to any information regarding the good, product, or article of commerce, and/or a link(s) or hyperlink(s) to any manufacturer, retailers, or retail sellers, of the good, product, or article of commerce. In this regard, the user or individual can utilize information contained or included in the report to shop for and/or to purchase the good, product, or article of commerce.

In the case of a multiple RFID tag read mode, at step 1306, the user or individual can review the information contained in the report, can search for only the good(s), product(s), or article(s) of commerce in which he or she is interested, and can engage in any shopping activity regarding the good(s), product(s), or article(s) of commerce, which was/were equipped with, or assigned, the RFID tag(s) 30 which was/were detected and read. In a preferred embodiment, in addition to any information regarding the good, product, or article of commerce, and/or the good, product, or article, information, for each respective good, product, or article of commerce, the report can also contain information, for each respective good, product, or article of commerce, a link(s), or hyperlink(s) to any information regarding each respective good, product, or article of commerce, and/or a link(s) or hyperlink(s) to any manufacturer, retailers, or retail sellers, of each respective good, product, or article of commerce. In this regard, the user or individual can utilize information contained or included in the report to shop for and/or to purchase the any good(s), product(s), or article(s) of commerce, in which the user or individual is interested.

At step 1307, the central processing computer 10 can record and store any information regarding any detected and read RFID tags 30, any good(s), product(s), or article(s) of commerce, assigned to the RFID tags 30, any and/or all of the herein-described information requests, any and/or all of the herein-described reports, in the database 10H as well as in the user's or individual's user account. In instances when a purchase was made via a link or hyperlink, or any other information, contained or included in any of the herein-described reports, information regarding the purchase or purchases can also be stored in the database 10H as well as in the user's or individual's user account. Thereafter, the operation of the apparatus 100 can cease at step 1308.

In another preferred embodiment of FIG. 13, at any time before, during, or after, the herein-described operation of the apparatus 100, the central processing computer 10, any/or any one or more of the venue computers 50, the manufacturing computers 60, the retailer computers 70, the advertising/marketing entity computers 80, the social network computers 90, and/of the financial institution computers 95, can, transmit information, marketing materials or information, advertising materials or information, social networking information, and/or any other materials or information to user communication 20/RFID reader combination and/or to any other user communication device 20 used by, or associated with the user or individual.

In another preferred embodiment, a payment, a referral fee, or a commission payment, can be calculated by the central processing computer 10 and can be paid to a financial account of any user or individual if the detection and reading of an RFID tag 30 registered to that user or individual results in a purchase of the respective good, product, or article of commerce, or any other good, product, or article of commerce, of any manufacturer, retailer, or retail seller, which is a member of, or which utilizes, the apparatus 100 of the present invention.

In another preferred embodiment, the apparatus 100 can be utilized to detect and read any and/or all RFID tags 30, each associated with a respective good(s), product(s), or article(s) of commerce, which enter into any event or venue. In such a preferred embodiment, RFID readers 50L of the venue computer 50 associated with the respective venue where the event to activity is taking place, other RFID readers, or any RFID reader systems 40, can be located at venue entrances to the event or activity so as to detect and to read each RFID tag 30 which enters into the venue, event or activity. At any time before, during, or after, the event the event of activity, information regarding each detected and read RFID tag 30 can be transmitted to the central processing computer 10, and a venue, event, or activity, report can be generated containing of including, for each detected and read RFID tag 30, information regarding the good, product, or article of commerce, and/or the good, product, or article, information, for each respective good, product, or article of commerce, to which a respective detected and read RFID tag 30 is assigned or registered. The venue, event, or activity, report can also contain or include information, for each respective good, product, or article of commerce, a link(s), or hyperlink(s) to any information regarding each respective good, product, or article of commerce, and/or a link(s) or hyperlink(s) to any manufacturer, retailers, or retail sellers, of each respective good, product, or article of commerce.

The user or individual can, at any time, request to retrieve, obtain, or otherwise be provided with, the venue, event, or activity, report, which can be searchable so as to allow the user of individual to search for one or more good(s), product(s), or article(s) of commerce.

In a preferred embodiment, the user or individual can, using his or her user communication device 20, review the venue, event, or activity, report, search the venue, event, or activity, report using any search words, terms, or phrases, and/or use any search filters, in order to retrieve, obtain, or otherwise be provided with the information regarding each good, product, or article of commerce, associated with each detected and read RFID tag 30, which is of interest to the user or individual. In a preferred embodiment, as and for an example, a user or individual, who may have seen a good, product, or article of commerce, which may have caught his or her attention, such as a woman user attending a formal event who has seen a dress, gown, other item of clothing, or accessory, worn by or possessed by another woman in attendance at the venue, event, or activity, can request, and can be provided with, and review, the venue, event, or activity, report to see if the respective dress, gown, other item of clothing, or accessory was equipped with an RFID tag 30 and, if so, allow the woman to obtain information regarding the respective dress, gown, other item of clothing, or accessory.

FIG. 14 illustrates another preferred embodiment method for utilizing the apparatus and methods of the present invention, in flow diagram form. In a preferred embodiment, it is envisioned that the venue at which an event or activity is being held, will be equipped with a venue computer 50 and with one or more RFID readers 50L, RFID readers, or RFID reader systems 40, with at least one RFID reader 50L, RFID reader, or RFID reader systems 40, being stationed at each entrance to the venue. With reference to FIG. 14, the operation of the apparatus 100 can commence at step 1400.

At step 1401, each RFID reader 50L, each RFID reader, or each RFID reader system 40, which is located at a respective entrance to the venue, event, or activity, can detect and read the RFID tags 30 which pass though the respective entrance at which each respective RFID reader 50L, each respective RFID reader, or each respective RFID reader system 40, is located or stationed. At step 1402, each respective RFID reader 50L, RFID reader, or RFID reader system 40, at step 1401, at any pre-determined time interval(s) or at any time, can provide or transmit information regarding any and/or all of the RFID tags 30 which were detected and read at the venue, event, or activity, to the venue computer 50.

At step 1403, the venue computer 50 can generate an information request regarding all of the RFID tags 30 detected and read during the predetermined time interval or at any time. In a preferred embodiment, the information request can also contain or include information regarding the name of the venue, the event, or the activity, and the date and time the information request was generated. At step 1403, the venue computer 50 can transmit the information request to the central processing computer 10.

At step 1404, the central processing computer 10 can receive the information request and can process any and/or all of the information contained or included therein, which was transmitted from the venue computer 50 at step 1303.

At step 1405, the central processing computer 10 can generate a venue, event, or activity, report which can contain or include, for each RFID tag 30 which was detected and read at the venue, the event, or the activity, information regarding the good, product, or article of commerce, and/or the good, product, or article, information, for the respective good, product, or article of commerce, equipped with, or assigned, the respective RFID tag 30. The venue, event, or activity, report can also contain or include information regarding the name of the venue, the event, or the activity, and the date and time the venue, event, or activity, report generated. At step 1405, the central processing computer 10 can store the venue, event, or activity, report.

At step 1406, the central processing computer 10 can transmit the venue, event, or activity, report to the user communication device 20 associated with any user or individual who may have previously posted a request with the central processing computer 10 to receive the same for the respective venue, event, or activity. It is envisioned that any user or individual, whether or not they attend the venue, event, or activity, or whether or not they attended the venue, event, or activity, can post a request that the venue, event, or activity, report be transmitted from the central processing computer 10 to his or her user communication device 20. At step 1406, any user or individual, whether or not they attend the venue, event, or activity, or whether or not they attended the venue, event, or activity, can also, at any time before, during, or after, the event of activity, access the central processing computer 10, using his or her user communication device 20, and can transmit a request to receive the venue, event, or activity, report. At step, 1406, if the user or individual accesses the central processing computer 10 and requests to receive the venue, event, or activity, report, the central processing computer 10 can receive and process the request, and can transmit the venue, event, or activity, report to the user's or individual's user communication device 20.

Regardless of whether or not the venue, event, or activity, report was previously requested, in a preferred embodiment, at step 1406, the venue, event, or activity, report can be transmitted directly to the respective user communication 20 and/or to any other user communication device 20 used by, or associated with the user or individual. In another preferred embodiment, the venue, event, or activity, report can also be transmitted to the user communication 20 and/or to any other user communication device 20 used by, or associated with, the user or individual, as, in, or as an attachment to, an email server associated with the user or individual, or as a text message or any other electronic transmission or communication.

At step 1407, the user or individual can obtain and review the venue, event, or activity, report. At step 1407, the user or individual can also search the venue, event, or activity, report for only the good(s), product(s), or article(s) of commerce in which he or she is interested, and can engage in any shopping activity regarding the good(s), product(s), or article(s) of commerce, which was/were equipped with, or assigned, the RFID tag(s) 30 which was/were detected and read. In a preferred embodiment, in addition to any information regarding the good, product, or article of commerce, and/or the good, product, or article, information, for each respective good, product, or article of commerce, the venue, event, or activity, report can also contain information, for each respective good, product, or article of commerce, a link(s), or a hyperlink(s), to any information regarding each respective good, product, or article of commerce, and/or a link(s) or hyperlink(s) to any manufacturer, retailers, or retail sellers, of each respective good, product, or article of commerce. In this regard, the user or individual can utilize information contained or included in the venue, event, or activity, report to shop for and/or to purchase the any good(s), product(s), or article(s) of commerce, in which the user or individual is interested.

At step 1408, the central processing computer 10 can record and store any information regarding any detected and read RFID tags 30, any good(s), product(s), or article(s) of commerce, assigned to the RFID tags 30, any and/or all of the herein-described information requests, any and/or all of the herein-described venue, event, or activity, report reports, in the database 10H as well as in the user's or individual's user account. In instances when a purchase was made via a link or hyperlink, or any other information, contained or included in any of the herein-described venue, event, or activity, reports, information regarding the purchase or purchases can also be stored in the database 10H as well as in the user's or individual's user account. Thereafter, the operation of the apparatus 100 can cease at step 1409.

In another preferred embodiment, the venue computer 50 can generate, and can transmit to the central processing computer 10, multiple information requests at any predetermined time intervals and/or at any time. Each information request can include information regarding the date and time the information request was generated. In a preferred embodiment, the central processing computer 10 can generate a venue, event, or activity, report for each information request and can transmit or provide each venue, event, or activity, report to a respective user communication device 20 of any user(s) or individual(s) in the same manner described herein at step 1406.

In another preferred embodiment of FIG. 14, at any time before, during, or after, the herein-described operation of the apparatus 100, the central processing computer 10, any/or any one or more of the venue computers 50, the manufacturing computers 60, the retailer computers 70, the advertising/marketing entity computers 80, the social network computers 90, and/of the financial institution computers 95, can, transmit information, marketing materials or information, advertising materials or information, social networking information, and/or any other materials or information to the user communication 20 and/or to any other user communication device 20 used by, or associated with the user or individual.

In another preferred embodiment of the embodiment of FIG. 14, a payment, a referral fee, or a commission payment, can be calculated by the central processing computer 10 and can be paid to a financial account of any user or individual if the detection and reading of an RFID tag 30 registered to that user or individual results in a purchase of the respective good, product, or article of commerce, or any other good, product, or article of commerce, of any manufacturer, retailer, or retail seller, which is a member of, or which utilizes, the apparatus 100 of the present invention.

It is important to note that the database 10H of the central processing computer 10, in a preferred embodiment, can also contain and/or include any data and/or information described herein as being contained and/or included in any of the herein-described and respective databases 20H, 30H, 40H, 50H, 60H, 70H, 80H, 90H, and/or 95H. It is important to note that the database 10H of the central processing computer 10, as well as each of, and/or any and/or all of, the respective databases 20H, 30H, 40H, 50H, 60H, 70H, 80H, 90H, and/or 95H, can also contain and/or include any data and/or information needed and/or desired for performing any and/or all of the operations and functionality described herein as being performed by each of the central processing computer(s) 10, the user communication devices 20, the RFID reader systems 40, the venue computers 50, the manufacturer computers 60, the retailer computers 70, the advertiser/marketing entity computers 80, the social network computers 90, the financial institution computers 95, and/or the apparatus 100.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus, comprising:
an RFID reader, wherein the RFID reader is specially programmed to detect or to read an RFID tag located on or in, or attached to, or affixed to, a good, a product, or an article of commerce;
a processor, wherein the processor is specially programmed to control an operation of the apparatus;
a display, wherein the display is capable of displaying information regarding the good, the product, or the article of commerce, to which the RFID tag is assigned or associated;
a transmitter, wherein the transmitter transmits an information request regarding the detected or read RFID tag, wherein the information request is transmitted to a central processing computer; and
a receiver, wherein the receiver receives a report containing information regarding the good, the product, or the article of commerce, to which the RFID tag is assigned or associated, wherein the report is transmitted from the central processing computer;
wherein the RFID reader detects or reads the RFID tag located on or in, or attached to, or affixed to, the good, the product, or the article of commerce, wherein the RFID reader or the processor automatically generates the information request containing information regarding the RFID tag, and further where the display displays information contained in the report or information regarding the good, the product, or the article of commerce, to which the RFID tag is assigned or associated.

2. The apparatus of claim 1, wherein the RFID tag is a passive RFID tag.

3. The apparatus of claim 1, wherein the RFID tag is an active RFID tag.

4. The apparatus of claim 1, wherein the RFID reader is a reader for detecting or reading passive RFID tags.

5. The apparatus of claim 1, wherein the RFID reader is a reader for detecting or reading active RFID tags.

6. The apparatus of claim 1, wherein the RFID reader is programmed to automatically detect or read any number of RFID tags located within a predetermined distance or proximity of the RFID reader.

7. The apparatus of claim 1, wherein the RFID reader or the processor generates a plurality of information requests.

8. The apparatus of claim 1, wherein the apparatus is a cellular telephone, a smart phone, or a personal digital assistant.

9. The apparatus of claim 1, wherein the apparatus is watch or a smart watch.

10. The apparatus of claim 1, wherein the RFID reader is linked to the processor or to the apparatus via a wireless communication link.

11. The apparatus of claim 1, wherein the RFID reader is linked to the processor or to the apparatus via a Bluetooth communication link.

12. The apparatus of claim 1, wherein the good, the product, or the article of commerce, is an article of clothing.

13. The apparatus of claim 12, wherein the RFID tag is a laundry tag.

14. The apparatus of claim 1, wherein the RFID tag is waterproof or washable.

15. The apparatus of claim 1, wherein the good, the product, or the article of commerce, is a consumer good.

16. The apparatus of claim 1, wherein the good, the product, or the article of commerce, is a consumer electronics good.

17. An apparatus, comprising:
an RFID reader, wherein the RFID reader is specially programmed to detect or to read a plurality of RFID tags, wherein each RFID tag of the plurality of RFID tags is located on or in, or attached to, or affixed to, a good, a product, or an article of commerce, to which RFID tag is assigned of associated, and further wherein the RFID reader is located at or near an entrance to a venue, an event, or an activity;
a processor, wherein the processor is specially programmed to control an operation of the apparatus, and further wherein the processor is associated with the venue, the event, of the activity;
a display, wherein the display is capable of displaying information regarding a plurality of goods, products, or articles of commerce, wherein each good, product, or article of commerce, of the plurality of goods, products, or articles of commerce, has an RFID tag assigned to or associated with the good, the product, or the article of commerce;
a transmitter, wherein the transmitter transmits an information request regarding the plurality of RFID tags detected or read by the RFID reader, wherein the information request is transmitted to a central processing computer; and
a receiver, wherein the receiver receives a report containing, for each RFID tag of the plurality of RFID tags detected or read, information regarding the good, the product, or the article of commerce, to which each RFID tag is assigned or associated, wherein the report is transmitted from the central processing computer;
wherein the RFID reader detects or reads any number of the plurality of RFID tags which pass by or which pass through an entrance to the venue, the event, of the activity, wherein each RFID tag is located on or in, or attached to, or affixed to, the good, the product, or the article of commerce, to which each RFID tag is assigned or associated, wherein the RFID reader or the processor generates the information request regarding each RFID tag detected or read, and further wherein the display displays information contained in the report or, for each RFID tag detected or read. information regarding the good, the product, or the article of commerce, to which each RFID tag is assigned or associated.

18. The apparatus of claim 17, wherein the RFID reader is programmed to automatically detect or read any number of RFID tags which pass by or which pass through the entrance to the venue, the event, of the activity.

19. The apparatus of claim 17, wherein the RFID reader or the processor is programmed to automatically generate a plurality of information requests.

20. The apparatus of claim 17, wherein the good, the product, or the article of commerce, is an article of clothing, a consumer good, or a consumer electronics good, and further wherein the RFID tag is waterproof or washable.
